(19) United States
(12) Patent Application Publication
(10) Pub. No.: US 2011/0295759 A1
(43) Pub. Date: Dec. 1, 2011

(54) METHOD AND SYSTEM FOR MULTI-SOURCE TALENT INFORMATION ACQUISITION, EVALUATION AND CLUSTER REPRESENTATION OF CANDIDATES

(75) Inventors: Paaul Randhip Selvakummar, Streamwood, IL (US); Herald Ignatius Poulose Manjooran, Hoffman Estates, IL (US)

(73) Assignee: FORTE HCM INC., Hoffman Estates, IL (US)

(21) Appl. No.: 13/110,813

(22) Filed: May 18, 2011

Related U.S. Application Data
(60) Provisional application No. 61/348,535, filed on May 26, 2010.

(51) Int. Cl. G06Q 10/00

(52) U.S. Cl. 705/321

(57) ABSTRACT

Embodiments of the invention relate to a system, method and apparatus for performing a multi-source talent acquisition. The method includes entering search criteria; selecting at least one source from a plurality of sources; executing a search using at least the search criteria and the at least one source; identifying at least one talent match; and displaying the at least one talent match.

### CLAIM FOR PRIORITY

This application is related to, and claims priority from, U.S. Provisional Application No. 61/348,535 filed May 26, 2010 titled “Method and System for Multi-Source Talent Information Acquisition, Evaluation, and Cluster Representation of Candidates” the complete subject matter of which is incorporated herein by reference in its entity.

### FIELD OF THE INVENTION

The present invention relates generally to computing systems and data processing. More specifically, it relates to a computer system and method for acquiring information on prospective candidates from multiple sources and evaluating their candidacy for job openings.

### BACKGROUND OF THE INVENTION

The term Human Capital refers to the stock of talent and ability embodied within the workforce population of an organization. More simply stated, it refers to the people that make an organization. While companies have always recognized the importance of human capital to their economic growth, the accelerated shift to knowledge-based economy in recent times has further accentuated its importance. Thus, the ability to identify and hire the right talent in the shortest amount of time possible coupled with the ability to retain such hired talent is vital to an organization's ability to stay on top of the global economy. This has direct bearing on the talent acquisition mechanisms available to organizations today to achieve these goals.

Typically, when an organization needs to hire a new employee, either on a permanent basis or contract basis, often times the hiring manager in collaboration with the human resources manager, drafts a position profile that describes the characteristics expected of the new employee. The position profile typically consists of a detailed description of the role, the skills, knowledge, experience and education required to perform in the role, the team profile, cultural aspects, duration of the position, and commercial aspects associated with the position. This then is published to either an in-house corporate recruitment team and/or a recruitment agency for fulfillment.

Traditionally, the group in-charge of fulfilling the job opening advertises the position on print or electronic media and receives resumes from prospective candidates in response to the advertisement. The resumes are then manually reviewed to assess the qualifications of the candidate, and those candidates whose resumes appear to reflect the qualifications called for in the position are then invited for an interview. This process has several drawbacks associated with it, some of which include the limited reach of the job advertisement and manual review of the resumes which is time consuming and error prone. This not only results in qualified candidates either not applying for the position due to the poor reach of the advertisements or not being invited for an interview due to human error in the manual resume review process, but also resumes of less qualified candidates being assessed incorrectly leading to loss of time and possible mis-hire.

Prior art systems such as job boards address these inadequacies to some extent by providing tools for candidates seeking new opportunities to upload their resumes into their system. In addition to advertising the job opening, recruiting agents are offered tools to perform searches for prospective candidates from amongst those candidates that have posted their resumes on the job board's system. This process requires for the recruiting agent to specify to the system a set of keywords representing the skills/qualifications expected of the candidate and then execute a search. Often times, the prior art system executes a textual keyword search through the body of text contained in the candidates' resumes, and returns to the user those resumes that have occurrences of the keywords specified by him.

One of the major drawbacks of this method is that the use of keyword search to identify prospective candidates more often than not results in a large number of resumes being returned to the user as matches with only a fraction of these results being likely ‘true matches’, the contributory reason being that a textual word match is all that it takes for a resume to get qualified as a match. Often times, such systems do not have the ability to discern the context in which such keywords appear on the candidate's resume, thus likely returning a candidate with five or more occurrences of a certain keyword under his academic coursework section done over a decade ago above a candidate with four occurrences of the same keyword in a description related to his work on a current project. Thus, it is left to the user yet again to manually review the large number of resumes returned by the system to weed out the pseudo-matches and identify truly qualified candidates for further assessment. This process has several problems associated with it. The most obvious of the problems is the amount of time consumed in reviewing the large number of results to identify the ‘true’ matches. Even comprehensive keywords specification most times result in matches numbering in the thousands, with no means of identifying the pseudo-matches from the true-matches without a manual visual review through each of the resumes. In addition to being a daunting task, the limited amount of time available to recruiting agents to fulfill positions more often than not causes them to oversee qualified resumes and in the process lose out on the talented candidates that they belong to.

As a result, it would be desirable to provide a talent acquisition system that is capable of analyzing resumes in a more human-like fashion, particularly with the ability to understand the context of use of keywords contained within the body of text contained in a candidate's resume.

Another inherent problem presented by job board systems is the tendency to favor ‘active’ candidates over ‘passive’ candidates while presenting search results to the user. Active candidate refers to those candidates that have engaged in recent activity on the job board system. This could include uploading a resume, making changes to an existing resume, applying for a position on the job board etc. The reasoning behind favoring ‘active’ candidates over ‘passive’ candidates while presenting them to the user is to increase the likelihood of availability of the candidate picked by the user from amongst the large number of search results returned to him. Assuming that the user is unlikely to browse past the first fifty or so results out of the total thousand presented to him, it makes intuitive sense for the system to position the active candidates over the passive candidates while presenting them to the user. While this appears as an elegant solution, the approach reveals another critical setback. Often times, the most talented of candidates are those that are already engaged on assignments and far less frequently not on one. These are candidates that are seldom actively looking for other engagements. In other words, these are passive candidates. Considering the possibility that the candidate that the recruiting agent is seeking belongs to the passive candidate pool, there is a fair amount of chance that the candidate's profile never makes it to the purview of the agent while executing a search using the approach indicated above.

While the value delivered by resumes in talent search cannot be denied, excessive reliance on resumes alone as a source of information on prospective talent by prior art systems has its pitfalls. This is particularly more pronounced when it comes to using them to shortlist the first set of candidates of interest. First, resumes are a candidate's representation about himself. Since there is no central authority reviewing and standardizing the representations made by candidates, resume content is highly subjective in nature. A candidate, therefore, whose resume takes a conservative approach to describing his experience, would likely have a significantly different hit-rate compared to a candidate with almost identical experience that takes a more superlative approach to description of his capabilities on his resume. Second, in addition to embellishments, falsification of facts on resume by unscrupulous candidates is a known problem in the industry. While background checks (employment and education verification) performed by organizations serve to screen out such candidates, it must be remembered that such screening typically happens much later in the hiring process. By this time, genuinely qualified candidates whose resumes lost out in the search results to falsified and embellished resumes, are likely no longer available, not to mention of the loss of time and money for organizations and recruitment agencies due to the prolonged search. Third, due to limitations of space, resumes are unable to adequately capture all of a candidate's experience and capabilities. At the best, they serve to summarize his or her career in a manner that best appeals to all of the targeted audience. This lends itself to the problem of a resume likely not having sufficient occurrence of the specific keywords used by a recruiting agent as part of his search criteria, and as a result not getting showcased when search results are presented to the user.

Thus, there are serious drawbacks to relying on resumes alone as the only source of information on prospective talent in the first stage of search process while attempting to identify and shortlist candidates for further assessment, particularly using the keyword search approach employed by prior electronic systems. There is a huge benefit to be derived, both in terms of cost and time, if we have a mechanism that enables us to identify truly qualified prospective resources right at the first stage of the talent search process. More specifically, a mechanism that is capable of accessing and analyzing objective and standardized information on a candidate's capabilities, in addition to being able to execute a contextual information search through resumes, in order to identify and recommend talent.

An example of such objective and standardized information is assessment data. Most hiring processes typically involve administration of one or more forms of assessment, such as tests and interviews, to candidates in order to assess the suitability of the candidate for the targeted position. Often times, while the results of such assessments are put to great use in determining the suitability of the candidate for that specific position, no formal mechanisms exist to leverage the information gathered over an extended period of time, as a result of many such assessments that the candidate would have been administered, in analyzing and recommending his or her suitability during first level searches executed for other positions in the future. There is immense value in such data, and it would be desirable to provide a system that is capable of analyzing a candidate's performance across multiple past assessments that have relevance to the skills and qualifications embodied in the position profile that a search is currently being executed for, either in whole or part.

Another drawback presented by prior art systems relates to the method used to present matching candidates to the user. Often times, candidates that are deemed to match the criteria specified by the user are generally presented in a textual list format that typically spans over multiple pages depending on the number of matching candidates. Given the likelihood of the large number of candidates returned to the user as a result of a search, this method of presentation makes it difficult to not only ascertain the relevancy of one specific candidate to the search in relation to other displayed candidates, but also ascertain the similarities between displayed candidates.

### SUMMARY OF THE INVENTION

Embodiments of the present invention relate to a computer system, method and apparatus that serve to address the inadequacies of the prior act systems described in the previous section. The system, method and apparatus comprises a multi-source talent information acquisition system that provides users engaged in the hiring/recruitment process an integrated platform to execute precision searches and view talent that has been identified, evaluated and ranked based on information procured from multiple sources. The system, method and apparatus further comprises performing contextual information search on candidate resumes, in order to better assess the level of candidate's familiarity with the search criteria, by evaluating the context of occurrence of each search term on the candidate's resume. The system, method and apparatus further comprises ability to integrate with assessment systems, access, retrieve and analyze information relating to candidate performance in order to evaluate candidature for the position, based on standardized and objective information. The system, method and apparatus further comprises a multidimensional profile imaging approach to representing candidate information, where candidates with similar profiles are clustered together in a multidimensional characteristics space. The system, method and apparatus further comprises representation of candidates by means of graphical objects such as spheres in a two dimensional space where candidates with similar profiles are clustered together. The system, method and interface further comprise ability to integrate with a position profile registration system to access and retrieve search criteria pertaining to a predefined position. The system, method and apparatus further comprise ability to assign varying weightage to components of the search criteria. The system, method and apparatus further comprises utility to select and specify candidates for further assessment. The system, method and apparatus further comprises a user interface for search criteria specification, source selection, search results display, search summary display, candidate information and reports display, resume and profile image display, and a panel to select and specify candidates for further assessment.

One embodiment of the present invention relates to a method for performing a multi-source talent acquisition, the method including entering search criteria; selecting at least one source from a plurality of sources; executing a search using at least the search criteria and the at least one source; identifying at least one talent match; and displaying the at least one talent match.

One or more embodiments relate to entering the search criteria including assigning varying weightage to components of the search criteria; integrating with a position profile registration system to access and retrieve the search criteria pertaining to a predefined position; accessing and analyzing objective and standardizing information on a candidate's capabilities and executing a contextual information search through at least one resume to identify and recommend talent: integrating with at least one assessment system, accessing, retrieving and analyzing relating to a candidate's performance for evaluating candidature for a position, based at least on standardized and objective information; analyzing a candidate's performance across multiple past assessments having relevance to skills and qualifications embodied in a position profile for which at least a part of a search is being executed for; searching and evaluating candidates based on information stored in an interview system; computing a candidate's fit as it pertains to a specified search criteria utilizing interview assessment data, taking into account a volume of historical assessment data available for each candidate and defined weightage for at least one search term and candidate performance across the at least one question relevant to the search term, and the complexity of the such question; acquiring resumes using instructions that monitors arrival of new resumes into a candidate information system resume repository by a multisource talent acquisition system and processing the resumes; and/or representing candidates using graphical objects in a two dimensional space, where candidates with similar profiles are clustered together.

One or more embodiments relate to one or more methods operating on a system for computing a total candidate test score for at least one candidate utilizing parameters, the system including a memory for storing instructions and data, the data include a set of programs and a dataset having one or more data fields; and a server that executes the instructions and processes the data. One or more embodiments of the system may include integrating with a position profile registration system to access and retrieve the search criteria pertaining to a predefined position; accessing and analyzing objective and standardizing information on a candidate's capabilities and executing a contextual information search through at least one resume to identify and recommend talent; computing a candidate's fit as it pertains to a specified search criteria utilizing interview assessment data, taking into account a volume of historical assessment data available for each candidate and defined weightage for at least one search term and candidate performance across the at least one question relevant to the search term, and the complexity of such question; and/or acquiring resumes using instructions that monitors arrival of new resumes into a candidate information system resume repository by a multisource talent acquisition system and processing the resumes.

Still another embodiment relates to a method for performing a multi-source talent acquisition, the method including computing a candidate's fit as it pertains to a search criteria specified by a user utilizing test assessment data taking into account a volume of historical assessment data available for each candidate, user defined weightage for each search term and a performance of a candidate across all questions relevant to a search term.

Still one or more embodiments relate to a method for performing a multi-source talent acquisition, the method including performing a contextual information search on the resumes; evaluating a context of occurrence of each search term on the resumes in order to efficiently value real-world project experience; efficiently valuing at least one recent project experience; and identifying and valuing possible certifications and specialist level skills.

One or more embodiments of the method include constructing profile images for at least one candidate using the at least one candidate's resume and an XML record, where the profile image is a multidimensional artifact encapsulating a holistic representation of the at least one candidate's skills, experience and qualifications; representing candidate information in a multidimensional artifact where candidates with similar profiles are clustered together in a multidimensional characteristic space; computing a recency factor for each project on the candidate's XML record where there is an occurrence of the search term; identifying a number of occurrences of star terms in proximity of the occurrences of each search term in the candidate's resume, where star terms indicate a degree of superiority of a skill used in the resume, and where proximity is defined as a word distance range from the search term that the star terms are to be looked and accounted for; and/or computing a candidate's resume score for each search term based on a number of occurrences of the search term, context of the occurrence, recency of use, number of occurrences of star terms with proximity of the search term.

Yet one or more embodiments relate to a method operating on a system, the system including a memory for storing instructions and data, the data including a set of programs and a dataset having one or more data fields; and a server that executes the instructions and processes the data; constructing profile images for at least one candidate using the at least one candidate's resume and an XML record, where the profile image is a multidimensional artifact encapsulating a holistic representation of the at least one candidate's skills, experience and qualifications; representing candidate information in a multidimensional artifact where candidates with similar profiles are clustered together in a multidimensional characteristic space; and/or computing a candidate's resume score for each search term based on a number of occurrences of the search term, context of the occurrence, recency of use, number of occurrences of star terms with proximity of the search term.

Still another embodiment relates to one or more methods operating on an integrated platform executing precision searches and viewing talent that has been identified, evaluated and ranked based on information procured from multiple sources, the platform including a multi-source talent acquisition system that executes instructions and processes data. In at least one embodiment a user interface communicates with at least the multi-source talent acquisition system enabling specifying a search criteria, selecting a source, displaying search results, displaying search summaries, displaying candidate information and reports, displaying resume and profile images, and providing a panel to select and specify candidates for further assessment.

The foregoing and other features and advantages of the invention will become further apparent from the following detailed description of the presently preferred embodiment, read in conjunction with the accompanying drawings. The drawings are not to scale. The detailed description and drawings are merely illustrative of the invention rather than limiting, the scope of the invention being defined by the appended claims and equivalents thereof.

### BRIEF DESCRIPTION OF THE DRAWINGS

FIG. 1 is a schematic representation of a system and method according to the present invention;

FIG. 2 is an illustration of an exemplary hardware arrangement for implementing the method and system of FIG. 1;

FIG. 3 is a schematic representation of a system and method according to the present invention;

FIG. 4 is a flow chart representing operation of elements of FIG. 1;

FIG. 5 is an exemplary web page for the method and system of FIG. 1;

FIG. 6 is an exemplary web page for the method and system of FIG. 1;

FIG. 7 is an exemplary web page for the method and system of FIG. 1;

FIG. 8 shows exemplary scenarios of the search criteria entry phase of the system and method of the present invention;

FIG. 9 is an exemplary web page for the method and system of FIG. 1;

FIG. 10 is a flow chart illustrating the search criteria entry phase of the system and method of the present invention;

FIG. 11 is a flow chart illustrating the search criteria entry phase of the system and method of the present invention;

FIG. 12 is a flow chart of an embodiment of the method and system of the present invention using test data as a source;

FIG. 13 is a flow chart of an embodiment of the method and system of the present invention using test data as a source;

FIG. 14 is an illustration of an exemplary Venn diagram;

FIG. 15 is a flow chart of an embodiment of the method and system of the present invention using interview data as a source;

FIG. 16 is a flow chart of an embodiment of the method and system of the present invention using interview data as a source;

FIG. 17 is a flow chart of an embodiment of the method and system of the present invention using resumes as a source;

FIG. 18 illustrates an exemplary template for a candidate XML record;

FIG. 19a illustrates an exemplary profile image template;

FIG. 19b illustrates an exemplary profile image for a candidate;

FIG. 19c illustrates an exemplary profile image for a candidate;

FIG. 20 is a flow chart of an embodiment of the method and system of the present invention using resumes as a source;

FIG. 21a is an exemplary web page for the method and system of FIG. 1;

FIG. 21b is an exemplary web page for the method and system of FIG. 1;

FIG. 22 is an exemplary web page for the method and system of FIG. 1;

FIG. 23 is an exemplary web page for the method and system of FIG. 1;

FIG. 24 is an exemplary web page for the method and system of FIG. 1;

FIG. 25 is an exemplary web page for the method and system of FIG. 1;

Throughout the various figures, like reference numbers refer to like elements.

### DETAILED DESCRIPTION OF PRESENTLY PREFERRED EMBODIMENTS

In the description that follows, the subject matter of the method and system will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer which reconfigures or otherwise alters the operation of the computer in a manner well understood by those skilled in the art. The data structures where data is maintained are physical locations of the memory that have particular properties defined by the format of the data. However, although the subject matter of the application is being described in the foregoing context, it is not meant to be limiting as those skilled in the art will appreciate that some of the acts and operations described hereinafter can also be implemented in hardware, software, and/or firmware and/or some combination thereof.

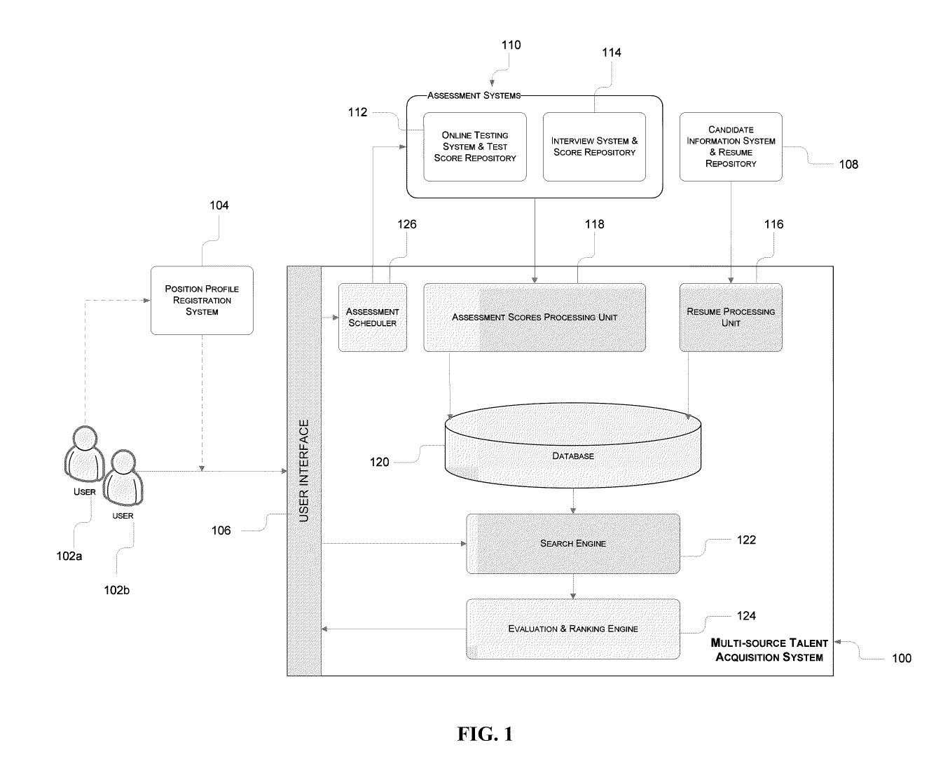

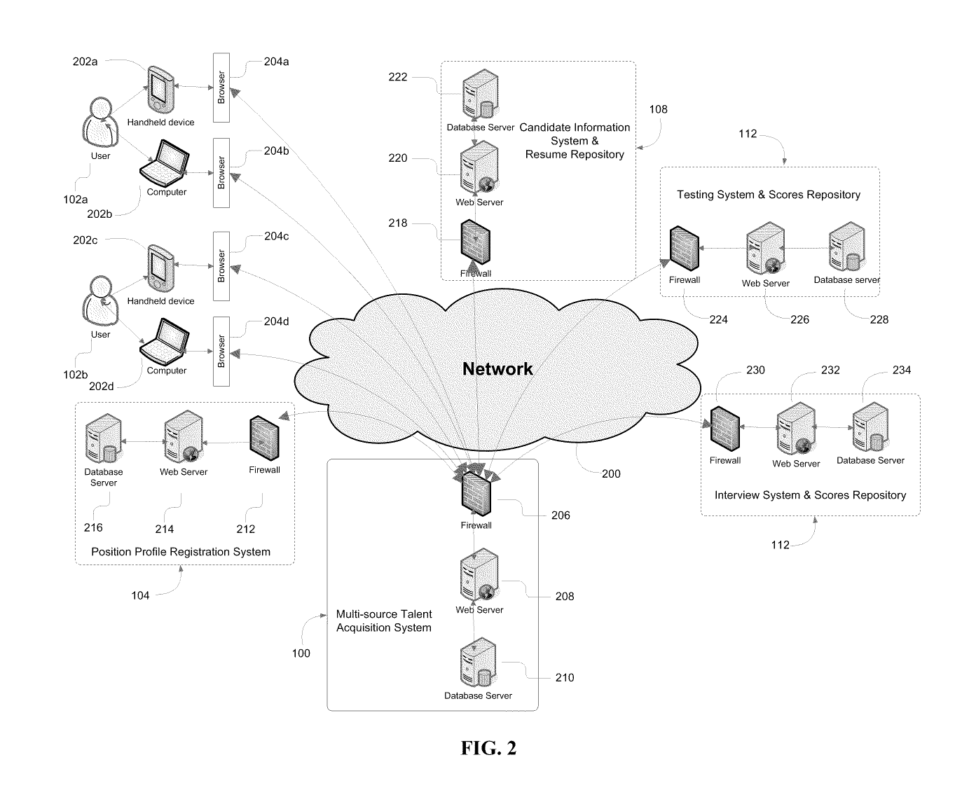

FIG. 1 illustrates a high-level overview of the method and system proposed in the present invention. The method and system of the present invention can be accomplished using a variety of hardware arrangements. FIG. 2 illustrates an exemplary hardware arrangement. The multi-source talent acquisition system 100 is data connected with the position profile registration system 104, candidate information system/resume repository 108, test system/test scores repository 112, and the interview system/interview scores repository 114. Position profile registration system refers to a method and system used by hiring managers and recruiting agents to define and register details about a position that they are seeking to fill by means of a position profile. In one embodiment, the position profile consists of a position name, position number, position type (contract, fulltime, etc.), location, duration, detailed description of the role, the skills, knowledge, experience and education required to perform in the role, the team profile, cultural aspects, and commercial aspects associated with the position. In a further embodiment, each of the skills within a position profile is associated with a weight that is intended to indicate the importance of that skill in relation to the rest of the skills defined within the position profile. A test system refers to a method and system that facilitates administering tests to candidates and recording the performances of candidates in such tests. In one embodiment, the test system is a web-based system that enables administration of tests over the internet and for candidates to take up the test remotely from a location of their choice. Candidate performance for each question of the test is monitored, captured and stored in a repository by the test system. In one embodiment, the interview system is a method and system that enables scheduling and administration of interviews to candidates, and recording of scores that indicate candidate performances in such interviews.

An embodiment of the multi-source talent acquisition system is composed of a web server 208 and a database server 210, which communicate with the network 200 through a firewall 206. The web server 208 and database server 210 include a computer with a display, input/output devices, processor, memory and storage device. The computer uses any one of the commercially available operating systems such as Windows Server 2003, and runs a commercially available web server application such as Internet Information Services. The database server 210 includes any relational database such as SQL Server. The software programs that represent the disclosed methods reside in the storage device, and are executed by the processor.

The position profile registration system 104, candidate information system/resume repository 108, test system/test score repository 112, and interview system/interview score repository 114 are each composed of a web server (214, 220, 226, 232) and database server (216, 222, 228, 234) that include a computer with a display, input/output devices, processor, memory and storage device and communicate with the network 200 through a firewall (212, 218, 224, 230). In one embodiment, one or more of the systems listed above share a common web server and data server. In an alternate embodiment, the systems are housed in separate web servers and data servers and communicate with each other through the network 200.

In one embodiment, user 102a communicates with the multi-source talent acquisition system 100 through the network 200 by operating a computer 202b. The computer 202b is a personal computer or a laptop that includes a display, input/output devices, processor, memory and data storage, and runs any of the commercially available operating systems such as Windows XP, Windows Vista etc. In another embodiment, user 102a communicates with the multi-source talent acquisition system 100 through the network 200 by operating a handheld device 202a such as a cell phone. The handheld device 202a and computer 202b invoke browsers 204a and 204b respectively for the user 102a to communicate with the multi-source talent acquisition system 100. Examples of browser 204a and 204b include Internet Explorer, Mozilla Firefox, and Safari.

The hardware components shown in FIG. 2 and those described above are intended to be illustrative of the components that they represent and are therefore exemplary in nature and not intended to limit the scope of the present invention.

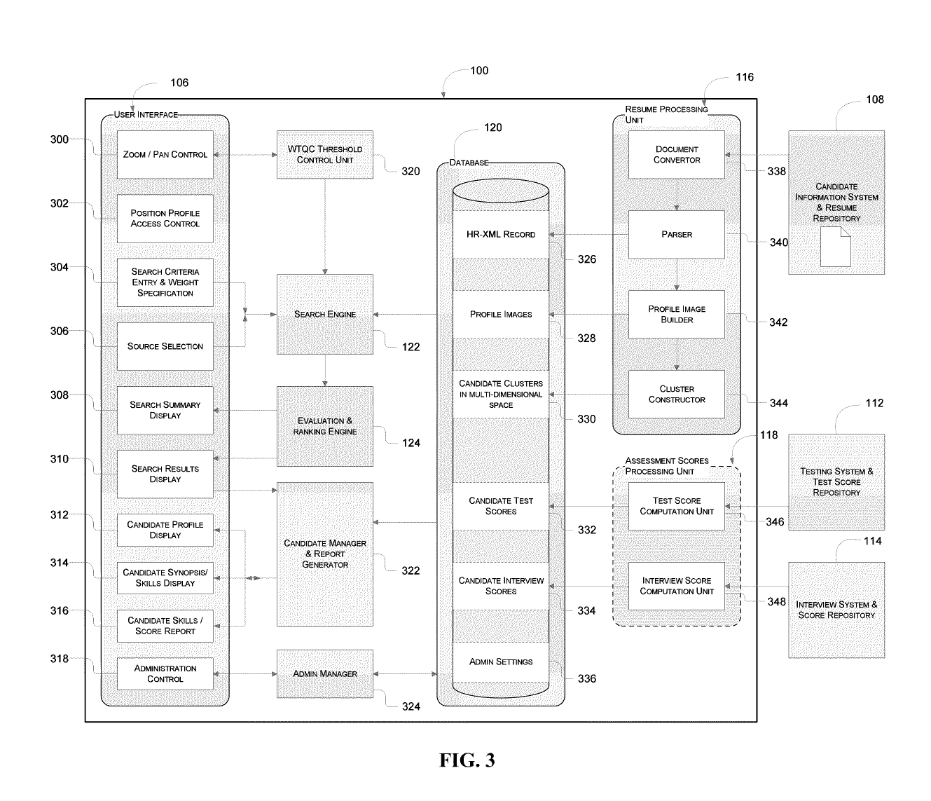

FIG. 3 illustrates a detailed view of the components included within the multi-source talent acquisition system 100. User interface 106 refers to the set of components displayed on the web page pertaining to the multi-source talent acquisition system 100 and is accessed by the user 102a on browser 204a. The components of the user interface 106 are represented by means of graphical elements on the web page and enable the user to interact with the software programs contained within the multi-source talent acquisition system 100. The programs contained within the multi-source talent acquisition system and the user interface can be implemented using a number of tools and languages suited for the purpose, some of which include .NET, Silverlight, Flex, etc. The components of the user interface 106 include position profile access control 302, search criteria entry and weight specification field 304, source selection utility 306, search results display 310, search results zoom/pan control 300, search summary display 308, candidate profile display 312, candidate synopsis/skills display 314, candidate score/report display 316, and administration control 318. The multi-source talent acquisition system 100 further includes a resume processing unit 116 that serves to access the candidate information system/resume repository 108 and process the retrieved resumes. The resume processing unit 116 further includes software programs such as document convertor 338, parser 340, profile image builder 342, and cluster constructor 344. The multi-source talent acquisition system 100 further includes an assessment scores processing unit 346 that serves to access the test system/test score repository 112 and the interview system/interview score repository 114, and process the retrieved information. The assessment scores processing unit 346 further includes software programs such as test score computation 346 and interview score computation 348. Information processed by the programs contained within the resume processing unit 116 and assessment scores processing unit 118 are stored in the database 120, also contained within the multi-source talent acquisition unit 100. Other programs contained within the multi-source talent acquisition system 100 include search engine 122, evaluation and ranking engine 124, WTQC (weighted total question count) threshold control 320, candidate manager & report generator 322, and admin manager 324.

The description above only serves to illustrate the components contained within an embodiment of the multi-source talent acquisition system 100. The methods represented by these components and their purposes will be more readily understood upon consideration of the attached diagrams and the rest of the detailed description contained within this document.

Method Overview

This section details an overview of the workings of the method and system proposed in the present invention. Subsequent sections will present embodiments of the method in finer detail. For purposes of illustration, search terms and skills pertaining to the field of Information Technology have been used. As those skilled in the art will understand, the method and system proposed in the present invention can be applied to a wide range of fields.

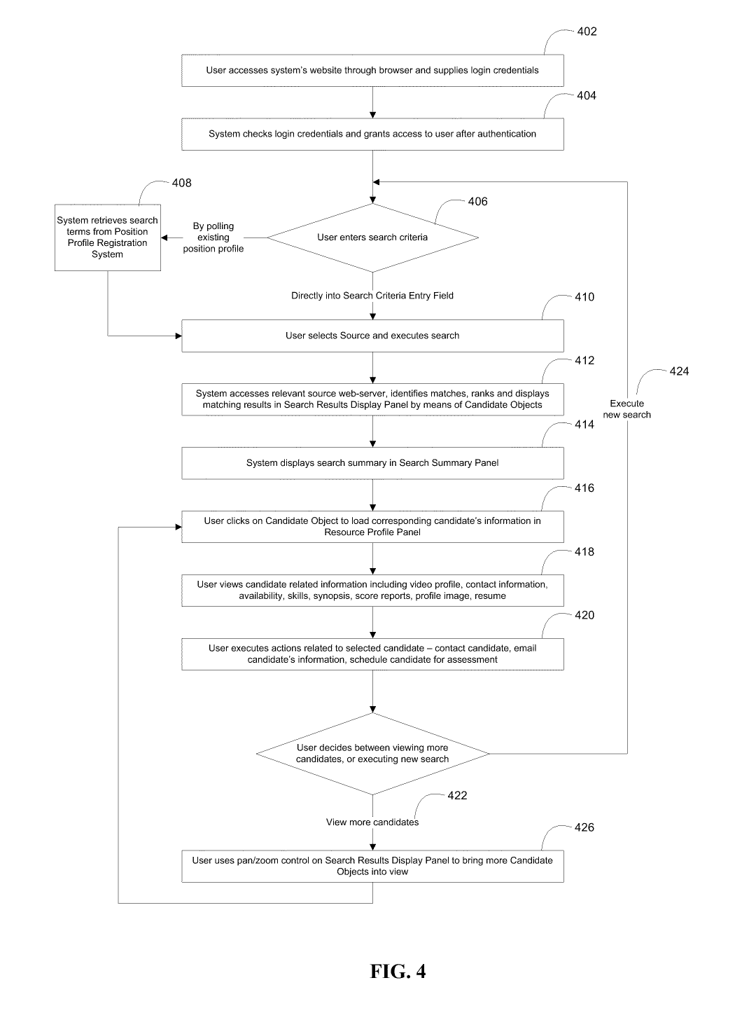

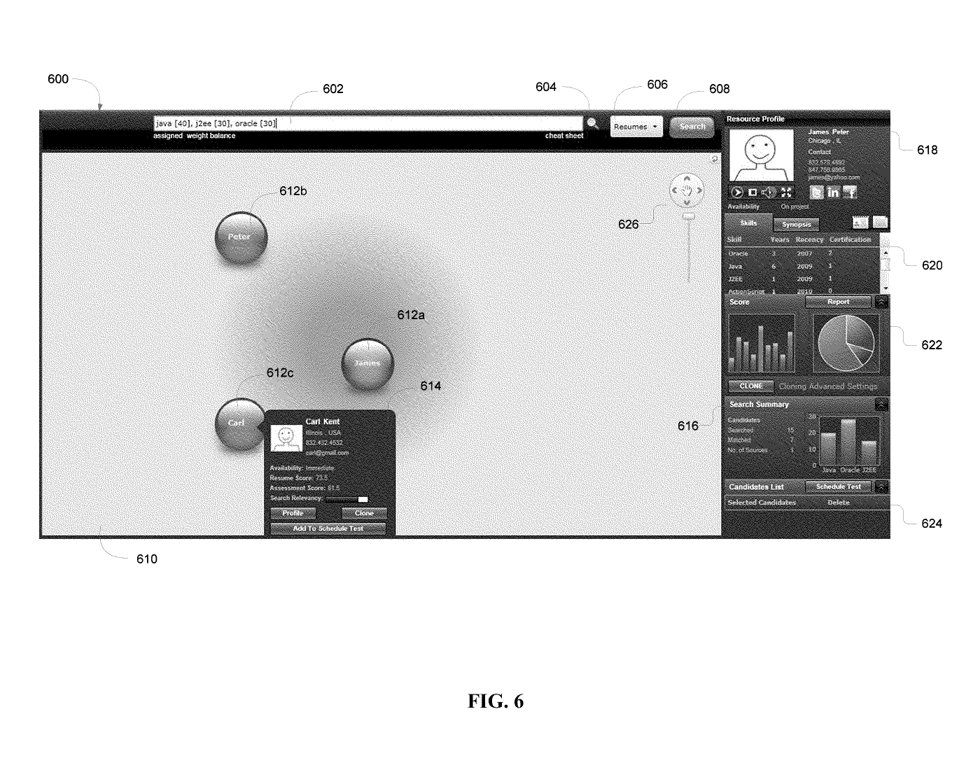

In FIG. 4, a flowchart representing the overview of the method is presented. FIG. 6 illustrates an exemplary screenshot of the webpage representing the multi-source talent acquisition system 100, as viewed by a user, after a search is executed. In one embodiment, referring to FIG. 4, in step 402, the user first accesses the multi-source talent acquisition system 100 by entering the uniform resource locator (URL) corresponding to the web server 208 hosting the multi-source talent acquisition system 100, in the browser.

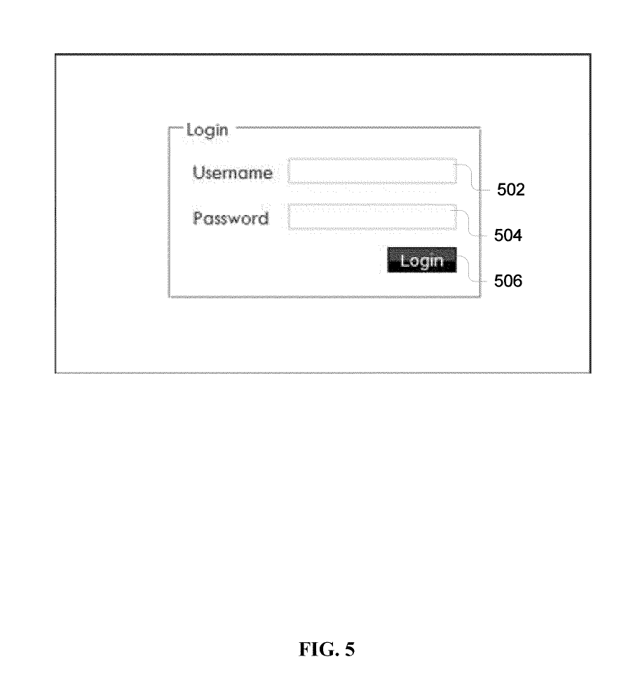

FIG. 5 illustrates an exemplary screenshot of the login webpage that is first presented to the user in his browser in response to his attempt to access the multi-source talent acquisition system 100. The user enters his username and password in the fields 502 and 504 respectively, and clicks on the login button 506. Referring to FIG. 4, in step 404, the login information is transmitted back to the multi-source talent acquisition system 100 through the network 200 for authentication. Once the user's login credentials have been authenticated, the user is presented with a webpage that represents the multi-source talent acquisition system's screen. The webpage is as illustrated in FIG. 6, but is devoid of any information related to the search criteria, search results or candidate.

Referring to FIG. 4, in step 406, the user enters the search criteria in field 602 of the webpage 600 as illustrated in FIG. 6. In one embodiment, the user enters the terms and associated weights representing the search criteria directly into the field 602. In another embodiment, the user loads the search terms from an existing position profile. The user does so by clicking on the search glass icon 604, and then performing a search for the specific position. In the latter case, the multi-source talent acquisition system connects with the position profile registration system 104, and retrieves information in regards to the desired position in order to display it on the webpage 600. In the example shown in FIG. 6, the user has entered the search criteria ‘Java [40], j2ee [30], oracle [30]’, where ‘Java’, ‘j2ee’, and ‘oracle’ are the skills sought, and the weightage assigned by the user for each of the terms are ‘40/100’, ‘30/100’, and ‘30/100’.

Referring to FIG. 4, in step 410, the user selects the source using the dropdown list 606. The dropdown list consists of the list of sources of information such as Resumes, Test System, and Interview System that the multi-source talent acquisition system has access to and that the user can base the search on. In one embodiment, the user selects one source from the list and initiates the search by clicking on the search button 608. This will execute a search based on the information present in that source. In an alternate embodiment, the user may select multiple sources in order for the system to execute a search based on the information contained within all of the selected sources at the same time.

Referring to FIG. 4, in step 412, the multi-source talent acquisition system 100 accesses the system corresponding to the source(s) selected by the user, identifies matches, ranks and displays results in the search results display panel 610. Each candidate that is part of the search result is represented on the search results display panel 610 by means of a candidate object 612a. In one embodiment, spheres labeled with the names of candidates are used as candidate objects. In alternate embodiments, any graphical shape/element may be used as candidate objects. In addition, per step 416 illustrated in FIG. 4, the web page 600 also displays a summary of the search results in the search summary display panel 616. The information displayed in the search summary display panel 616 includes ‘number of candidates searched’, ‘number of candidates that match the search criteria from amongst those searched’, ‘number of sources searched’, and a graphical chart to represent the number of matching candidates for each component of the search criteria.

When the user places the mouse pointer over a candidate object 612c, a profile snapshot window 614 pops open. The profile snapshot window 614 displays the candidate's name, location, contact details, availability, score, photo, and buttons for profile display and test scheduling. Information pertaining to the candidate displayed on the profile snapshot window 614 is procured by the multi-source talent acquisition system 100 from the candidate information system/resume repository 108.

Returning to FIG. 4, in step 416, when the user clicks on a candidate object 612a, information pertaining to the candidate represented by the candidate object 612a gets displayed on the candidate profile display panel 618, candidate synopsis/skills display panel 620, and the candidate score/report display panel 622. The candidate profile display panel 618 includes information such as candidate's name, location, contact details, video profile, availability status, and links to external websites that carry more information about the candidate. The synopsis/skills display panel 620 includes a skills matrix and a professional summary about the candidate, as well as links/icons to display the candidate's resume and profile image. The score/report display panel 622 includes graphical charts that represent a summary of the candidate's skills as it pertains to the search criteria, and a button/link to open a more detailed report of the candidate's standing as it pertains to the search criteria.

Referring to FIG. 4, in step 420, the user may now perform a wide variety of actions pertaining to the search. This includes and is not limited to viewing the candidate's video profile and accessing the candidate's external web pages from the candidate profile display panel 618, reviewing the candidate's skills, resume and profile image in the candidate synopsis/skills display panel 620, pulling up and reviewing a detailed report of the candidate's skills as it pertains to the search criteria in the score/report display panel 622. In addition, the user may also shortlist a candidate for further assessment, by selecting a candidate object 612a representing a candidate, and clicking on the schedule test button located in the shortlisted candidates panel 624. In another embodiment, the user may also add candidates to the list in the shortlisted candidates panel 624 by clicking on the ‘add to schedule test’ button in the profile snapshot window 614 that pops up while placing the mouse pointer over a candidate object.

Having reviewed the candidates presented on the search results display panel 610, the user may now choose to view more candidates for the existing search criteria (step 422 illustrated in FIG. 4) or execute a new search by specifying a new search criteria (step 424 illustrated in FIG. 4). In the case of the former, in step 426 illustrated in FIG. 4, the user zooms-out or pans using the zoom/pan control 626 to enable a higher level view of the search results display panel 610. This will result in more candidate objects coming into view on the search results display panel 610. The user may use the zoom/pan control 626 any number of times after a search is executed in order to control the number of candidate objects being displayed on the search results display panel 610. Should the user decide to start a new search, the user will return to step 406 illustrated in FIG. 4, and enter new search criteria in the search criteria entry field 602.

The rest of the document serves to describe each part of the method and system in finer detail.

Search Criteria Entry Phase

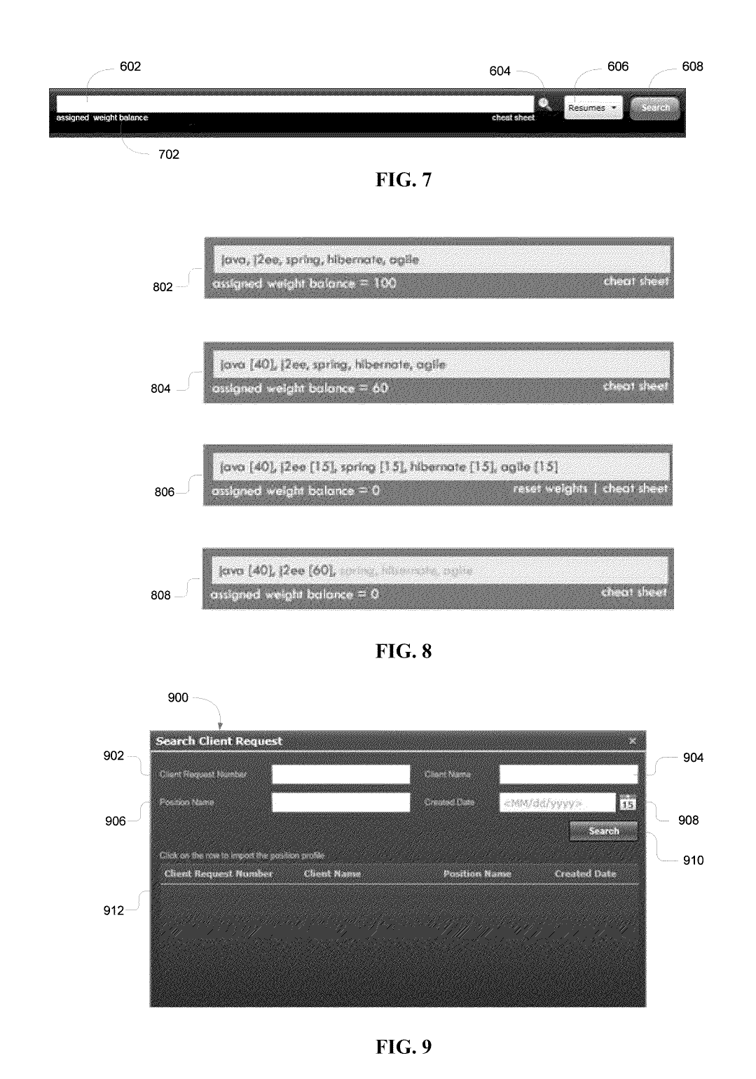

This is the first phase of the method, after a user has logged in to the multi-source talent acquisition system 100. The user specifies the search criteria as a set of search terms and weights associated with each search term. Weights specification enables the user to prioritize one skill over another while identifying talent. FIG. 7 shows a closer view of the section of the web page 600 that relates to search criteria entry. As indicated in the overview section, the system provides users with two methods of search criteria entry. In one embodiment, the user enters the terms and associated weights representing the search criteria directly into the field 602. In another embodiment, the user loads the search terms from an existing position profile.

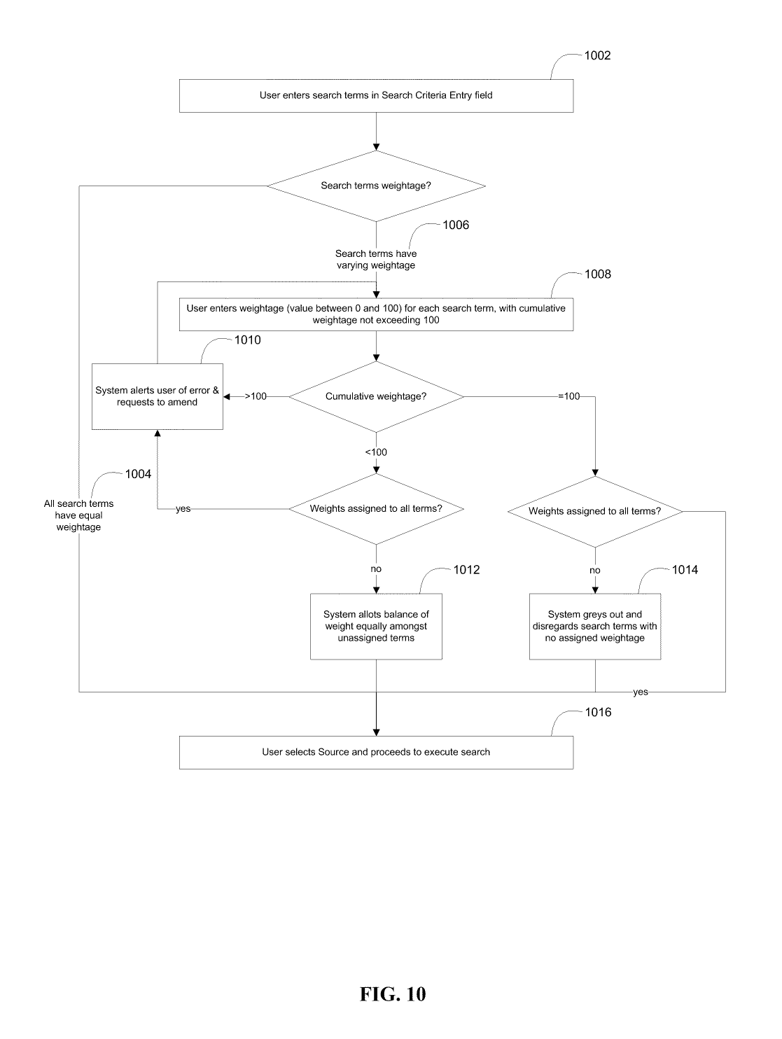

FIG. 10 is a flowchart that illustrates the method of the first embodiment, where the user directly enters the terms representing the search criteria. FIG. 8 illustrates various scenarios encountered in this method, and will be referenced to in the description that follows.

Referring to step 1004 of FIG. 10 and diagram 802 of FIG. 8, when a user regards all the search terms as being equally important, the user enters the terms delimited by commas into the search criteria entry field 602. In the example shown in diagram 802 of FIG. 8, the user has specified search terms ‘Java, j2ee, spring, hibernate, agile’. The multi-source talent acquisition system 100 would assume equal weightage for all terms while identifying and assessing prospective candidates. Also as it can be seen in diagram 802 of FIG. 8, the ‘assigned weight balance’ reads as 100, implying that no specific weight has been assigned to any of the search terms by the user.

Referring to steps 1006 and 1008 of FIG. 10, a user may choose to assign varying weightage to the search terms. The user does this by including the weight within ‘square brackets’ immediately following each search term in the search criteria entry field 602. The ‘assigned weight balance’ gets adjusted automatically to indicate the balance of weight points that are left to be assigned. Referring to FIG. 10, in step 1010, when the total of the weights assigned by the user to the search terms exceeds 100, the system will alert the user of the error, and request him to amend the weights allocation. Referring to step 1012 of FIG. 10 and diagram 804 of FIG. 8, when the user specifies weights for only some of the search terms before executing the search, the system will automatically allocate the balance of the unallocated weight points equally amongst the rest of the terms while identifying and assessing prospective candidates. Referring to the example shown in diagram 804 of FIG. 8, the user has chosen to indicate that the search term ‘Java’ occupies a weightage of 40 points out of a total of 100. The ‘assigned weight balance’ gets adjusted automatically to indicate the balance of weight points that can be user-assigned. Since the user has specified weight points for the term ‘Java’ alone, should the user now execute a search without indicating specific weight points for the rest of the terms, the system will automatically distribute the balance of the unallocated weight points equally amongst the rest of the terms. This will result in the following weight distribution: Java-40; J2EE-15; Spring-15; Hibernate-15; Agile-15. When the user clicks on the search button 608 after selecting a source from the dropdown list 606, the display in the search criteria entry field 602 will be updated by the system to reflect the weights as allocated by it, as shown in diagram 806 of FIG. 8.

Referring to step 1014 of FIG. 10 and diagram 808 of FIG. 8, when the user allots all of the available 100 weight points amongst only some of the search terms he specified in the search criteria entry field 602, it results in zero weight points left to be assigned and will cause the rest of the search terms to be grayed out, implying that they will not be included as part of the search criteria. However, the user may choose to modify this, and re-allot weights prior to executing the search, or in a subsequent search run. Referring to the example illustrated in diagram 808 of FIG. 8, the user has allotted all of the 100 weights points between only two of the search terms. This causes the rest of the search terms that have no weights left to be assigned to be grayed out, and not included as part of the search criteria.

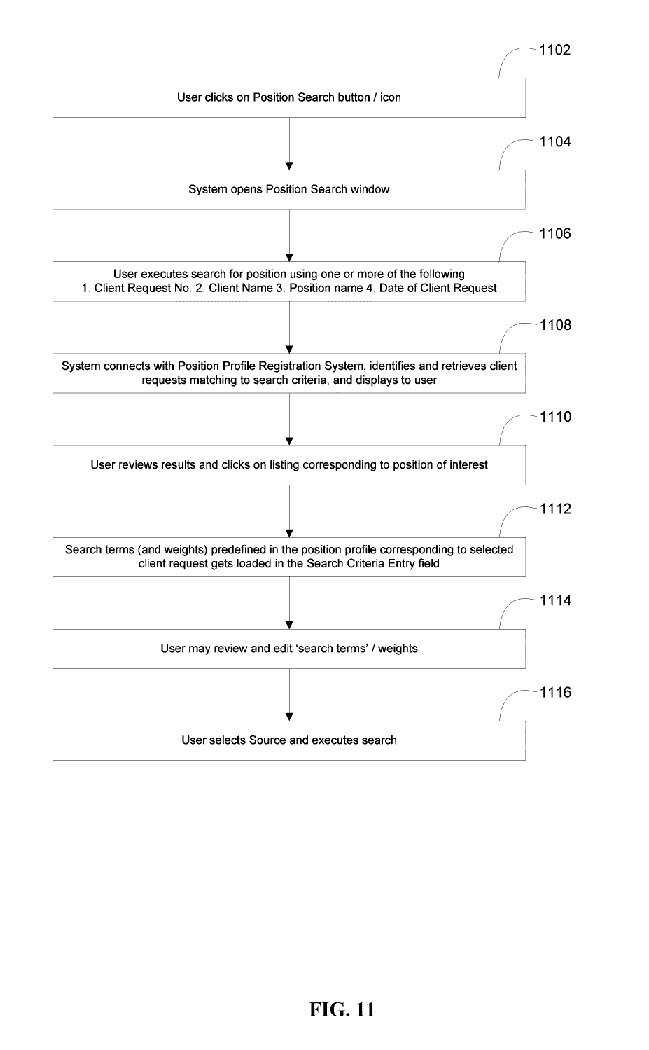

FIG. 11 is a flowchart that illustrates the method of the second embodiment, where the user loads the search terms from an existing position profile. FIG. 9 is a screenshot of the position search window that plays a role in this method. Referring to steps 1102 and 1104 of FIG. 11, the user clicks on the position search button represented by the search glass icon 604, causing the position search pop-up window 900 to open up. Referring to step 1106 in FIG. 11, the user executes a search for predefined positions by entering information in one or more of the fields contained in the position search pop-up window 900. These fields include position number 902, client name 904, position name 906, and position registration date 908. Referring to FIG. 11, in step 1108, when the user clicks on the search button 910, the multi-source talent acquisition system 100 accesses records in the position profile registration system 104, searches for positions that match the criteria specified by the user, and displays matching records in table 912 of the position search pop-up window 900. Referring to steps 1110 and 1112 off FIG. 11, when the user then reviews the results displayed in the table 912, and clicks on the listing corresponding to the position of interest, the search terms and weights predefined in the position profile corresponding to the selected position gets loaded in the search criteria entry field 602. The user thereafter reviews the search criteria and makes changes as required in the search criteria entry field 602 before selecting a source and executing a search by clicking on the search button 608.

Source Selection Phase

An embodiment of the multi-source talent acquisition system enables users to select and specify the sources of information that is to be used in identifying and evaluating prospective talent. In one embodiment, the choices of sources are presented to the user by means of a dropdown list 606 on the web page pertaining to the multi-source talent acquisition system. The choices can include sources such as resumes, test data, and interview data. The user selects one source from the list and initiates the search by clicking on the search button 608. This will execute a search based on the information present in that source. In an alternate embodiment, the choices of sources are presented to the user by means of a multiple-selection list enabling the user to select multiple sources in order for the system to execute a search based on the information contained within all of the selected sources at the same time. When the user specifies the source(s) and clicks the search button 608, the multi-source talent acquisition system will access the systems representing the specified sources, in order to search and evaluate information pertaining to prospective candidates based on the search criteria specified by the user. The next few sections will elaborate the method as it pertains to each of the sources.

Test Data as Source

Most hiring processes typically involve administration of one or more tests to candidates in order to assess the suitability of the candidate for the targeted position. The large majority of such tests are typically administered over the web, enabling candidates to take the tests remotely. In an alternate scenario, test systems that permit candidates to take up tests proactively for the purposes of self-evaluation and certification also exist. In one embodiment, the test system is integrated within the same platform as that of the multi-source talent acquisition system 100. In an alternate embodiment, the test system is external and communicates with the multi-source talent acquisition system 100 over a data network 200. Questions administered as part of such tests are characterized by the category and subject that it belongs to, a set of keywords known as tags that best describe the question, and complexity. When tests are administered, candidate performances for each question administered as part of that test are captured and stored in a repository. The candidate performance for each question is characterized by whether the candidate answered the question correctly, and the amount of time taken by the candidate to answer the question. Over a period of time, the amount of information captured in regards to a candidate's competencies in various skills as ascertained by his performance across multiple tests that have been administered to his in the past, can be of significant value in evaluating his suitability for the position under consideration currently.

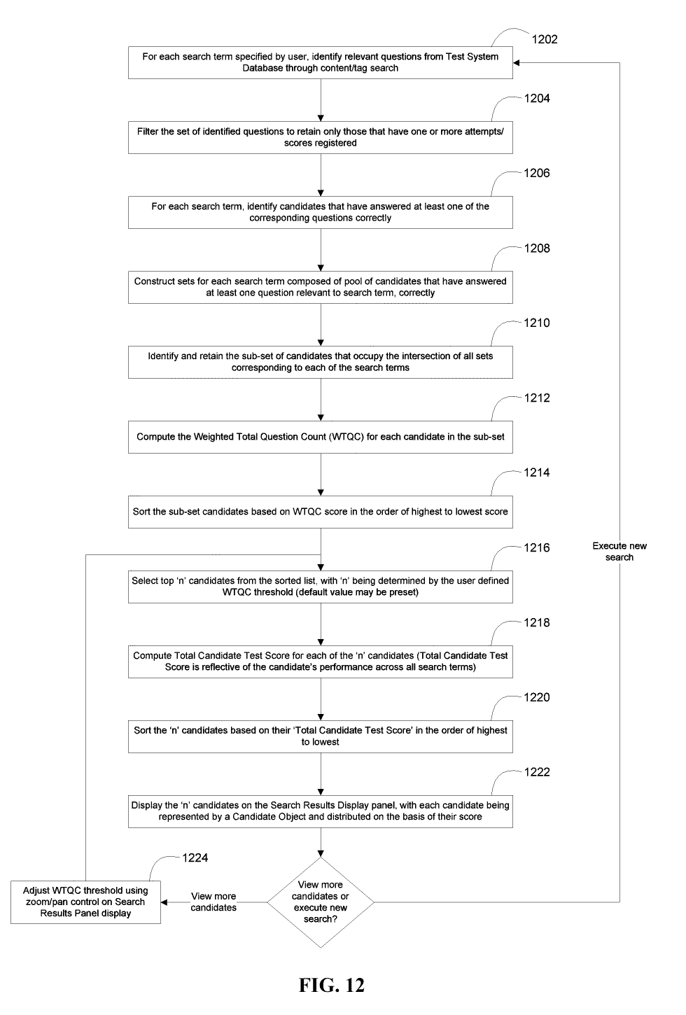

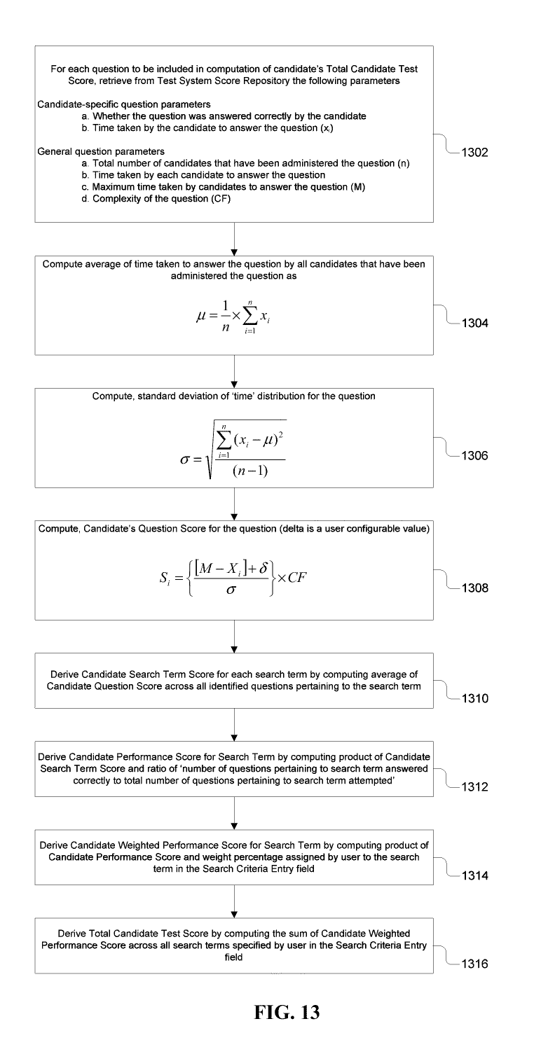

FIG. 12 is a flowchart that illustrates an overview of the method as it applies to searching for and evaluating candidates based on information stored in the test system 112. FIG. 13 is a flowchart that illustrates the method of computing the candidate's score as it pertains to the search criteria specified by the user. The process will encompass steps that will account for the volume of historical assessment data that is available for each candidate, user defined weightage for each search term (in picking the initial set of candidates, and in computing the final score), and the performance of the candidate across all questions relevant to a search term (including ones that the candidate failed to answer correctly).

Referring to FIG. 12, in step 1202, when the user enters the search criteria and clicks on the search button, the multi-source talent acquisition system 100 accesses the repository of questions in the database server 228 of the test system 112, and identifies questions that are relevant to the search criteria entered by the user in the search criteria entry field 602. In one embodiment, the system does this by searching through the content of the question and answer and the tags associated with each question to identify occurrences of each term contained within the search criteria. Questions that contain at least one search term are considered a match. Referring to FIG. 12, in step 1204, the system filters the set of identified questions in order to retain only those that have one or more attempts registered. In step 1206 illustrated in FIG. 12, candidates that have correctly answered at least one question corresponding to each of the search terms are identified. In step 1208, illustrated in FIG. 12, sets are constructed for each search term, with each set being composed of candidates that have answered at least one question relevant to the search term correctly. In step 1210, illustrated in FIG. 12, the system identifies and retains the sub-set of candidates that occupy the intersection of all sets corresponding to each of the search terms. This results in deriving the set of candidates that have correctly answered at least one question relevant to each of the search terms.

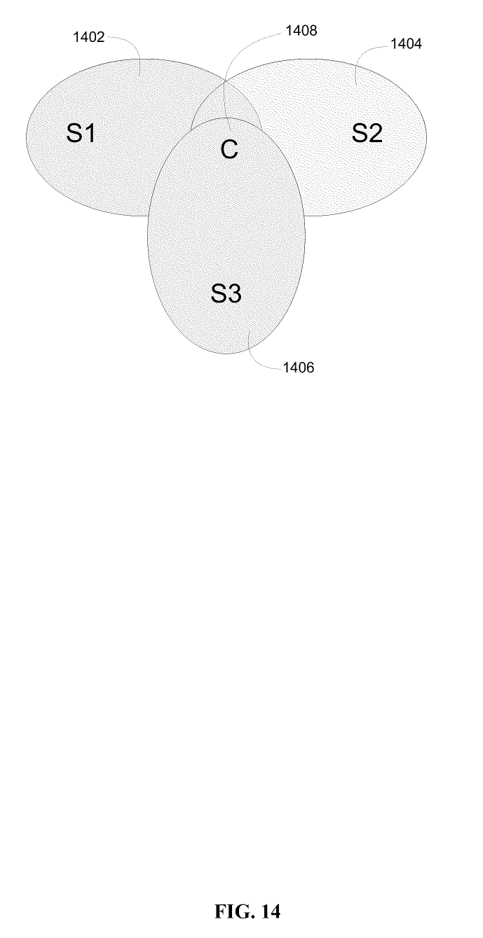

Referring to FIG. 14, if S1 1402, S2 1404, and S3 1406 represent sets composed of candidates that have correctly answered at least one question relevant to that search term, C 1408 refers to the sub-set of candidates sought in step 1210 illustrated in FIG. 12.
S1={set of candidates that have answered at least one question bearing search term T1, correctly}
S2={set of candidates that have answered at least one question bearing search term T2, correctly}
.
.
.
Sn={set of candidates that have answered at least one question bearing search term Tn, correctly}

C=S₁∩S₂∩ . . . ∩Sₙ

Returning to FIG. 12, in step 1212, the weighted total question count (WTQC score) is computed for each of the candidates identified in step 1210, illustrated in FIG. 12, as follows:

$$WTQC = n \times {\sum }_{i = 1}^{n} [ {QC}_{i} \times ( \frac{{w}_{i}}{100} ) ]$$

where WTQC is the ‘Weighted Total Question Count’ for the candidate, n is the number of search terms specified by the user, QC (Question Count) is the number of questions identified as being answered correctly by a candidate for a specific search term, and w is the user specified weightage for the specific search term.

Returning to FIG. 12, in steps 1214 and 1216, the sub-set of candidates C is sorted based on the weighted total question count (WTQC) in the order of highest to lowest, and the top ‘n’ candidates are selected from the sorted list. In one embodiment, ‘n’ is set based on the number of candidates to be displayed by default on the search results display 610. If the number of candidate objects to be made viewable by default on the search results display 610 when the results are first displayed after a search is completed is twenty, then ‘n’ is set as 20. The number of candidate objects displayed on the search results display can thereafter be tweaked by using the zoom/pan control 626 as will be detailed further on in the description. In an alternate embodiment, the user will have a slider made available to them on the web page 600, that they can use to select the WTQC threshold (minimum WTQC permissible) in order to control the number of candidates picked for score computation and eventually displayed. For instance, let us assume that the values of WTQC computed for candidates in subset C range from 10 to 100, and that the value of ‘n’ is set as 20 in the admin screen. Assuming that the candidate with the 20th highest WTQC score has a WTQC score of 60, the slider control's default position on the user's screen will be at 60 and the max and min values of the slider will be set at 100 and 10 respectively. Once the scores computation are completed, should the user now wish to include more prospective candidates in the mix, the user may move the slider control towards the ‘min value’ so that candidates with WTQC scores lower than 60 (corresponding to the 20th candidate) too are included for further score computation. Alternatively, should the user wish to further filter the number of prospective candidates based on WTQC, the user will move the slider control towards the ‘max value’.

Returning to FIG. 12, in step 1218, the total candidate test score is computed for each of the ‘n’ candidates with the highest WTQC scores. The flowchart in FIG. 13 illustrates the method of computing the total candidate test score for each candidate. Referring to FIG. 13, in step 1302, for each question to be included in computation of the candidate's total candidate test score, the following parameters are retrieved from the test system 112.

Candidate-Specific Question Parameters

a. Whether the question was answered correctly by the candidate

b. Time taken by the candidate to answer the question (xi)

General Question Parameters

a. Total number of candidates that have been administered the question (n)

b. Time taken by each candidate to answer the question

c. Maximum time taken by candidates to answer the question (M)

d. Complexity of the question (CF)

In step 1304, illustrated in FIG. 13, the average of the time taken to answer each question by all candidates that have been administered the question is calculated as

$$μ = \frac{1}{n} \times {\sum }_{i = 1}^{n} {x}_{i}$$

In step 1306, illustrated in FIG. 13, standard deviation of ‘time’ distribution for each question (where ‘time’ is time taken by all candidates that were administered the question) is computed as

$$σ = \sqrt{\frac{{\sum }_{i = 1}^{n} {( {x}_{i} - μ )}^{2}}{( n - 1 )}}$$

In step 1308, illustrated in FIG. 13, the candidate question score, which indicates the candidate's performance in each question, is computed as:

$${S}_{i} = \{ \frac{[ M - {X}_{i} ] + δ}{σ} \} \times CF$$

where M is the maximum time taken by candidates to answer the question, Xi is the time taken by the candidate to answer the question, δ is a small user defined offset value, and CF is the complexity factor of the question. Complexity factor refers to a numerical value that is representative of the complexity of a question. The following table is an example of complexity factors for a test system that categorizes questions into three levels of complexities.

| | Question Complexity | | |
|---|---|---|---|
| | Simple (S) | Medium (M) | Complex (C) |
| Complexity Factor | 1 | 1.5 | 2 |

As it can be seen, part of the formula used to compute the candidate's performance score involves statistical normalization of data. This is required, since the time-data for different questions could potentially be spread across different ranges. Typical statistical normalization involves conversion into normal distribution with a zero mean and a variance of one. However, since this would result in negative values for data points (which would be cumbersome for scoring), the formula above provides a normalization mechanism that drives the data point with the maximum time-data value towards a score of ‘almost’ zero, while ensuring that all points are assigned positive scores. While it might seem logical to simply assign a score of zero to the data point with the maximum value (M), it results in loss of ability to differentiate between a candidate that took the longest to answer a question with complexity S (simple), and one that took the longest to answer a question with complexity C (complex), since the complexity factor will cease to have any effect, when the preceding sub-formula results in a value of zero. This is addressed by the introduction of ‘δ’ in the formula above. δ will help provide a small user-defined offset in the scores, and will ensure that the complexity factor retains effect. In one embodiment, δ is defined as:

δ=0.1×σ

In alternate embodiments, δ will be a user configurable value that can be set using the administration control 318.

Returning to FIG. 13, in step 1310, the candidate search term score for each search term, is computed by calculating the average of the candidate question score across all identified questions pertaining to the search term. In step 1312, illustrated in FIG. 13, the candidate performance score for search term is derived by computing the product of the candidate search term score and the ratio of ‘number of questions pertaining to search term answered correctly to total number of questions pertaining to search term administered’. In step 1314, illustrated in FIG. 13, the candidate weighted performance score for search term is derived by computing the product of candidate performance score and weight percentage assigned by the user to the search term in the search criteria entry field 602. In step 1316, illustrated in FIG. 13, the total candidate test score is derived by computing the sum of candidate weighted performance score across all search terms specified by the user. The table below illustrates a snapshot of this process

| Candidate | | | | | C1 | | | | |
|---|---|---|---|---|---|---|---|---|---|
| Search Term | T1 | | | T2 | | | T3 | | |
| Search term | W1 | | | W2 | | | W3 | | |
| weights (as | | | | | | | | | |
| assigned by user) | | | | | | | | | |
| Questions | Q1 | Q2 | Q3 | Q4 | Q5 | Q6 | Q7 | Q8 | Q9 |
| Question Score | S1 | S2 | S3 | S4 | S5 | S6 | S7 | S8 | S9 |

| | | | |
|---|---|---|---|
| Search Term Score | AS1 = | AS2 = | AS3 = |
| | [S1 + S2 + S3]/3 | [S4 + S5 + S6]/3 | [S7 + S8 + S9]/3 |
| Performance Score | PS1 = AS1 × [ratio | PS2 = AS2 × [ratio | PS3 = AS3 × [ratio of |
| for Search Term | of no. of questions | of no. of questions | no. of questions |
| | pertaining to T1 | pertaining to T2 | pertaining to T3 |
| | answered correctly’ | answered correctly’ | answered correctly’ |
| | to ‘total number of | to ‘total number of | to ‘total number of |
| | questions pertaining | questions pertaining | questions pertaining |
| | to T1 attempted’] | to T2 attempted’] | to T3 attempted’] |
| Weighted | WAS1 = | WAS2 = | WAS3 = |
| Performance Score | PS1 × (W1/100) | PS2 × (W2/100) | PS3 × (W3/100) |

| | |
|---|---|
| Total candidate test | C1S = WAS1 + WAS2 + WAS3 |
| score | |

Returning to FIG. 12, in step 1220, the candidates for whom the total candidate test scores are computed are sorted based on the score in the order of highest to lowest. In step 1222, the candidates are displayed on the search results display panel 610, with each candidate being represented by a candidate object and distributed on the panel on the basis of their score, starting from the center of the search results display panel 610 and leading towards the periphery. After having reviewed the candidates displayed on the search results display panel 610, referring to step 1224, illustrated in FIG. 12, the user may now use the zoom/pan control 626 to enable viewing of more candidates on the screen. Zooming-out using the zoom/pan control 626 causes the WTQC threshold value to be lowered, which in turn increases the number of candidates that may be picked from the WTQC sorted list to have their total candidate test scores computed. This results in more candidates being available to be displayed on the search results display panel 610.

Interview Data as Source

Most hiring processes typically involve administration of one or more interviews to candidates in order to assess the suitability of the candidate for the targeted position. Certain interview systems support recording of the candidate's performance scores by the assessor at the completion of the interview. In one embodiment, the interview system is integrated within the same platform as that of the multi-source talent acquisition system 100. In an alternate embodiment, the interview system is external and communicates with the multi-source talent acquisition system 100 over a data network 200. Questions administered to candidates by assessor as part of such interviews are characterized by the category and subject that it belongs to, a set of keywords known as tags that best describe the question, and complexity. When interviews are administered, candidate performances for each question administered as part of the interview are captured and stored in a repository. The candidate performance for each question is typically characterized by a numerical value assigned by the assessor to indicate his evaluation of the candidate's response to the administered question. Over a period of time, the amount of information captured in regards to a candidate's competencies in various skills as ascertained by his performance across multiple interviews that have been administered to him in the past, can be of significant value in evaluating his suitability for the position under consideration currently.

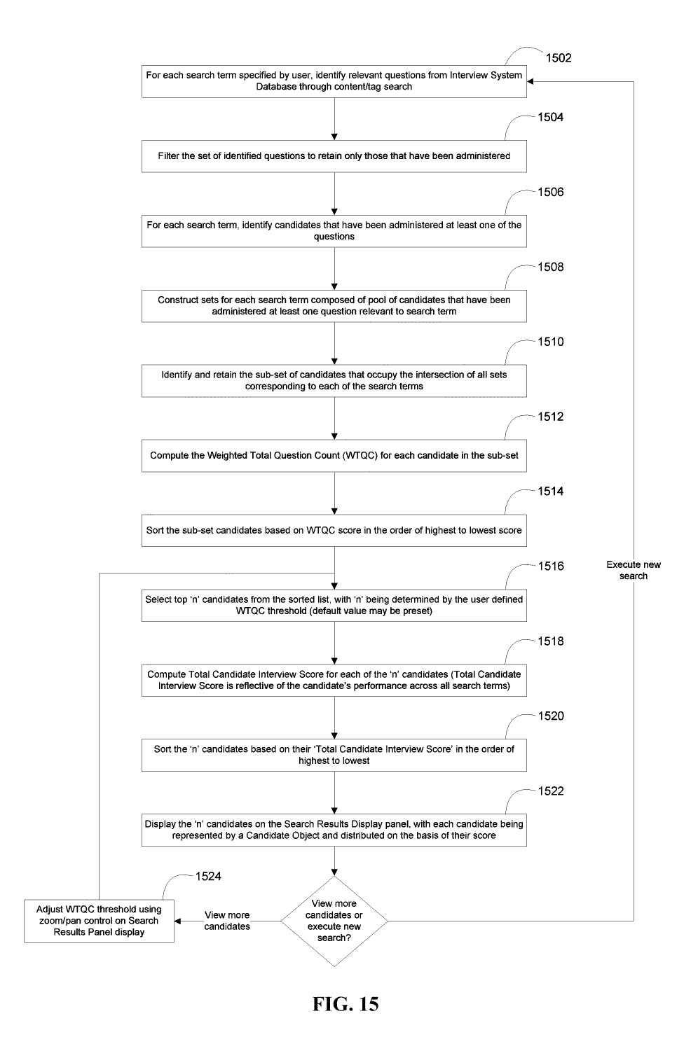

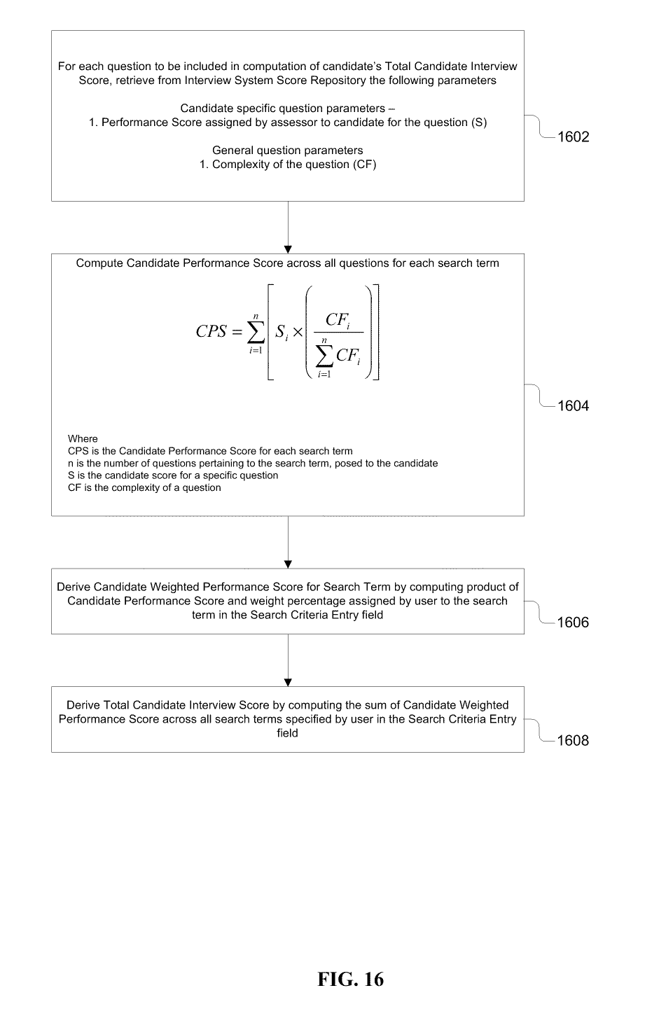

FIG. 15 is a flowchart that illustrates an overview of the method as it applies to searching for and evaluating candidates based on information stored in the interview system 114. FIG. 16 is a flowchart that illustrates the method of computing the candidate's score as it pertains to the search criteria specified by the user. The process will encompass steps that will account for the volume of historical assessment data that is available for each candidate, and user defined weightage for each search term (in picking the initial set of candidates, and in computing the final score).

Referring to FIG. 15, in step 1502, when the user enters the search criteria and clicks on the search button, the multi-source talent acquisition system 100 accesses the repository of questions in the database server 234 of the interview system 114, and identifies questions that are relevant to the search criteria entered by the user in the search criteria entry field 602. In one embodiment, the system does this by searching through the content of the question and answer and the tags associated with each question to identify occurrences of each term contained within the search criteria. Questions that contain at least one search term are considered a match. Referring to FIG. 15, in step 1504, the system filters the set of identified questions in order to retain only those that have been administered at least once. In step 1506, illustrated in FIG. 15, candidates that have been administered at least one question corresponding to each of the search terms are identified. In step 1508, illustrated in FIG. 15, sets are constructed for each search term, with each set being composed of candidates that have been administered at least one question relevant to the search term correctly. In step 1510, illustrated in FIG. 15, the system identifies and retains the sub-set of candidates that occupy the intersection of all sets corresponding to each of the search terms. This step results in deriving the set of candidates that have been administered at least one question relevant to each of the search terms.

Referring to FIG. 14, if S1 1402, S2 1404, and S3 1406 represent sets composed of candidates that have been administered at least one question relevant to that search term, C 1408 refers to the sub-set of candidates sought in step 1510, illustrated in FIG. 15.

S1={set of candidates that have answered at least one question bearing search term T1, correctly}

S2={set of candidates that have answered at least one question bearing search term T2, correctly}

Sn={set of candidates that have answered at least one question bearing search term Tn, correctly}

C=S₁∩S₂∩ . . . ∩Sₙ

Returning to FIG. 15, in step 1512, the weighted total question count (WTQC score) is computed for each of the candidates identified in step 1510, illustrated in FIG. 15, as follows:

$$WTQC = n \times {\sum }_{i = 1}^{n} [ {QC}_{i} \times ( \frac{{w}_{i}}{100} ) ]$$

where WTQC is the ‘Weighted Total Question Count’ for the candidate, n is the number of search terms specified by the user, QC (Question Count) is the number of questions identified as being administered to a candidate for a specific search term, and w is the user specified weightage for the specific search term.

Returning to FIG. 15, in steps 1514 and 1516, the sub-set of candidates C is sorted based on the weighted total question count (WTQC) in the order of highest to lowest, and the top ‘n’ candidates are selected from the sorted list. In one embodiment, ‘n’ is set based on the number of candidates to be displayed by default on the search results display 610. If the number of candidate objects to be made viewable by default on the search results display 610 when the results are first displayed after a search is completed is twenty, then ‘n’ is set as 20. The number of candidate objects displayed on the search results display can thereafter be tweaked by using the zoom/pan control 626 as will be detailed further on in the description. In an alternate embodiment, the user will have a slider made available to them on the web page 600, that they can use to select the WTQC threshold (minimum WTQC permissible) in order to control the number of candidates picked for score computation and eventually displayed. For instance, let us assume that the values of WTQC computed for candidates in subset C range from 10 to 100, and that the value of ‘n’ is set as 20 in the admin screen. Assuming that the candidate with the 20th highest WTQC score has a WTQC score of 60, the slider control's default position on the user's screen will be at 60 and the max and min values of the slider will be set at 100 and 10 respectively. Once the scores computation are completed, should the user now wish to include more prospective candidates in the mix, the user may move the slider control towards the ‘min value’ so that candidates with WTQC scores lower than 60 (corresponding to the 20th candidate) too are included for further score computation. Alternatively, should the user wish to further filter the number of prospective candidates based on WTQC, the user will move the slider control towards the ‘max value’.

Returning to FIG. 15, in step 1518, the total candidate interview score is computed for each of the ‘n’ candidates with the highest WTQC scores. The flowchart in FIG. 16 illustrates the method of computing the total candidate interview score for each candidate. Referring to FIG. 16, in step 1602, for each question to be included in computation of the candidate's total candidate interview score, the following parameters are retrieved from the interview system 114

a. Performance score assigned by assessor to candidate for the question (S)

b. Complexity of the question (CF)

In step 1504, illustrated in FIG. 15, the candidate performance score across all questions for each search term is computed as:

$$CPS = {\sum }_{i = 1}^{n} [ {S}_{i} \times ( \frac{{CF}_{i}}{{\sum }_{i = 1}^{n} {CF}_{i}} ) ]$$

where CPS is the candidate performance score for each search term, n is the number of questions pertaining to the search term administered to the candidate, S is the candidate score for a specific question, and CF is the complexity factor of a question. Complexity factor refers to a numerical value that is representative of the complexity of a question. The following table is an example of complexity factors for an interview system that categorizes questions into three levels of complexities.

| | Question complexity | | |
|---|---|---|---|
| | Simple (S) | Medium (M) | Complex (C) |
| Complexity Factor | 1 | 1.5 | 2 |

In step 1606, illustrated in FIG. 16, the candidate weighted performance score for search term is derived by computing the product of candidate performance score and weight percentage assigned by the user to the search term in the search criteria entry field 602. In step 1608, illustrated in FIG. 16, the total candidate interview score is derived by computing the sum of candidate weighted performance score across all search terms specified by the user. The table below illustrates a snapshot of this process

| Candidate | | | | | C1 | | | | |
|---|---|---|---|---|---|---|---|---|---|
| Search Term | T1 | | | T2 | | | T3 | | |
| Search term | W1 | | | W2 | | | W3 | | |
| weights (as | | | | | | | | | |
| assigned by user) | | | | | | | | | |
| Questions | Q1 | Q2 | Q3 | Q4 | Q5 | Q6 | Q7 | Q8 | Q9 |
| Question | S1 | S2 | S3 | S4 | S5 | S6 | S7 | S8 | S9 |
| Performance Score | | | | | | | | | |

| | | | |
|---|---|---|---|
| Candidate | CPS1 | CPS2 | CPS3 |
| Performance Score | | | |
| Weighted | WAS1 = | WAS2 = | WAS3 = |
| Performance Score | CPS1 × (W1/100) | CPS2 × (W2/100) | CPS3 × (W3/100) |

| | |
|---|---|
| Total candidate test | S = WAS1 + WAS2 + WAS3 |
| score | |

Returning to FIG. 15, in step 1520, the candidates for whom the total candidate interview scores are computed are sorted based on the score in the order of highest to lowest. In step 1522, illustrated in FIG. 15, the candidates are displayed on the search results display panel 610, with each candidate being represented by a candidate object and distributed on the panel on the basis of their score, starting from the center of the search results display panel 610 and leading towards the periphery.

After having reviewed the candidates displayed on the search results display panel 610, referring to step 1524 illustrated in FIG. 15, the user may now use the zoom/pan control 626 to enable viewing of more candidates on the screen. Zooming-out using the zoom/pan control 626 causes the WTQC threshold value to be lowered, which in turn increases the number of candidates that may be picked from the WTQC sorted list to have their total candidate test scores computed. This results in more candidates becoming available to be displayed on the search results display panel 610.

Resumes as Source

An embodiment of the multi-source talent acquisition system enables contextual information search on candidate resumes, in order to better assess the level of candidate's familiarity with the search criteria, by evaluating the context of occurrence of each search term on the candidate's resume. Through use of the contextual search approach, the multi-source talent acquisition system will be able to efficiently value real-world project experience, efficiently value recent project experience(s), and identify and value possible certifications and specialist level skills

In one embodiment, resumes are acquired by recruiters from candidates and are uploaded into a candidate information system/resume repository 108. In an alternate embodiment, resumes are uploaded directly into the candidate information system/resume repository 108 by candidates. In addition to the resumes, the candidate information system may also store other information related to the candidate including but not limited to the candidate's current location and address, contact details, photo and/or video profile, current availability, details of work currently engaged in, and uniform record locators to web pages that carry information about the candidate.

In one embodiment, the candidate information system/resume repository is integrated within the same platform as that of the multi-source talent acquisition system 100. In an alternate embodiment, the candidate information system/resume repository is external and communicates with the multi-source talent acquisition system 100 over data network 200.

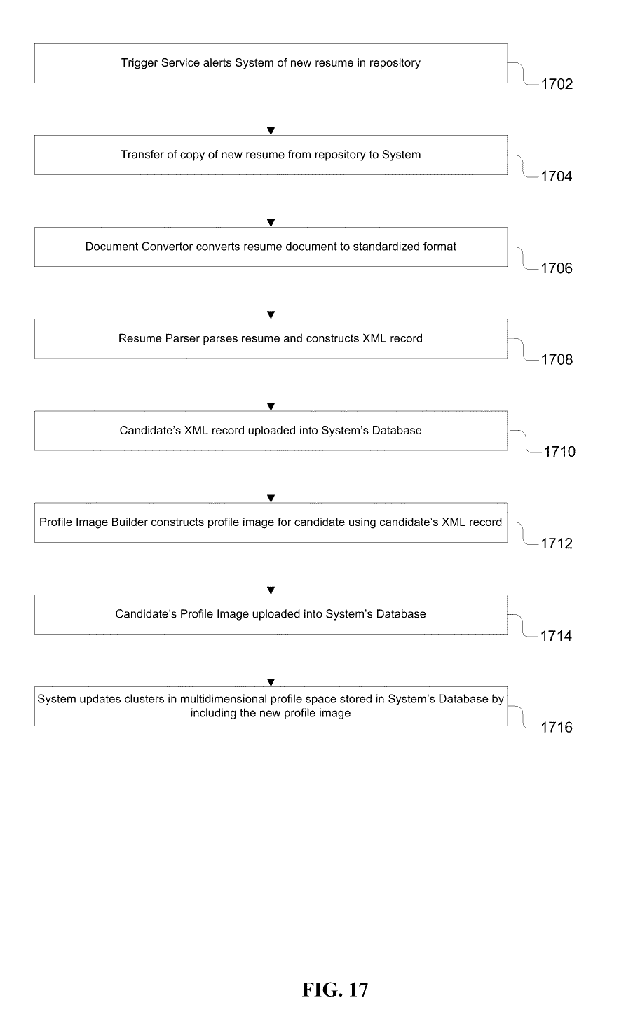

FIG. 17 is a flowchart that illustrates the method of acquisition of a resume by the multi-source talent acquisition system and the subsequent processing of it. In step 1702, illustrated in FIG. 17, a trigger service creates an alert whenever a new resume gets uploaded into the candidate information system/resume repository 108. The trigger service is a software program that keeps monitoring the arrival of new resume files into the candidate information system/resume repository 108, and generates a signal/message on realization of a new resume file being uploaded.

In step 1704, illustrated in FIG. 17, following the alert by the trigger service, a copy of the newly uploaded resume is transferred from the candidate information system/resume repository 108 to the multi-source talent acquisition system 100 using the file transfer protocol over the network 200. In one embodiment, this transfer happens immediately on receipt of the alert about the new resume file. In an alternate embodiment, a batch processing software program runs during prespecified intervals, such as once a day, and transfers files that have been uploaded since the last transfer.

In step 1706, illustrated in FIG. 17, the document convertor 338 software program, illustrated in FIG. 3, converts the transferred resume document to a standardized format. Since a variety of document formats, such as Microsoft Word and Adobe Portable Document Format (PDF), exist for candidates to publish their resumes in, the document convertor 338 enables conversion of the content contained within such documents to a standardized text format in order to facilitate further processing.

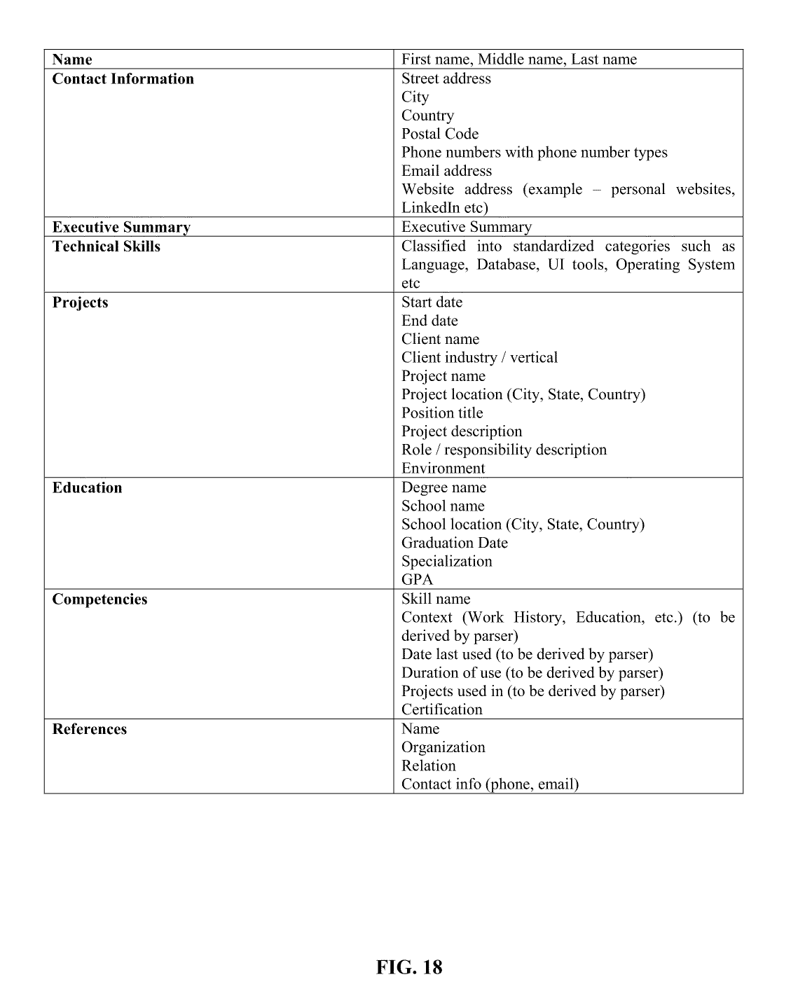

In step 1708, illustrated in FIG. 17, the standardized text document representing the resume is parsed by a parser software program 340 and an Extensible Markup Language (XML) record for the candidate is constructed based on the HR-XML resume schema. HR-XML is a library of XML schemas developed by the HR-XML consortium to support a variety of business processes related to human resource management. In one embodiment, the XML record of the candidate includes elements such as name, contact information, executive summary, technical skills matrix, projects, education, competencies and references. FIG. 18 illustrates an exemplary template for the XML record. In alternate embodiments, the XML record template may be customized based on the context of use. The parser 340 is a software program that scans and analyzes the textual content of the resume document, and extracts relevant information from the document in order to populate the fields within the XML record. If the recently uploaded resume is identified as belonging to an existing candidate, the candidate's existing XML record is retrieved from the database 120 and is updated based on the information acquired by parsing the recently uploaded resume.

In step 1710, illustrated in FIG. 17, the created/updated XML record is saved into the database 120 within the multi-source talent acquisition system 100.

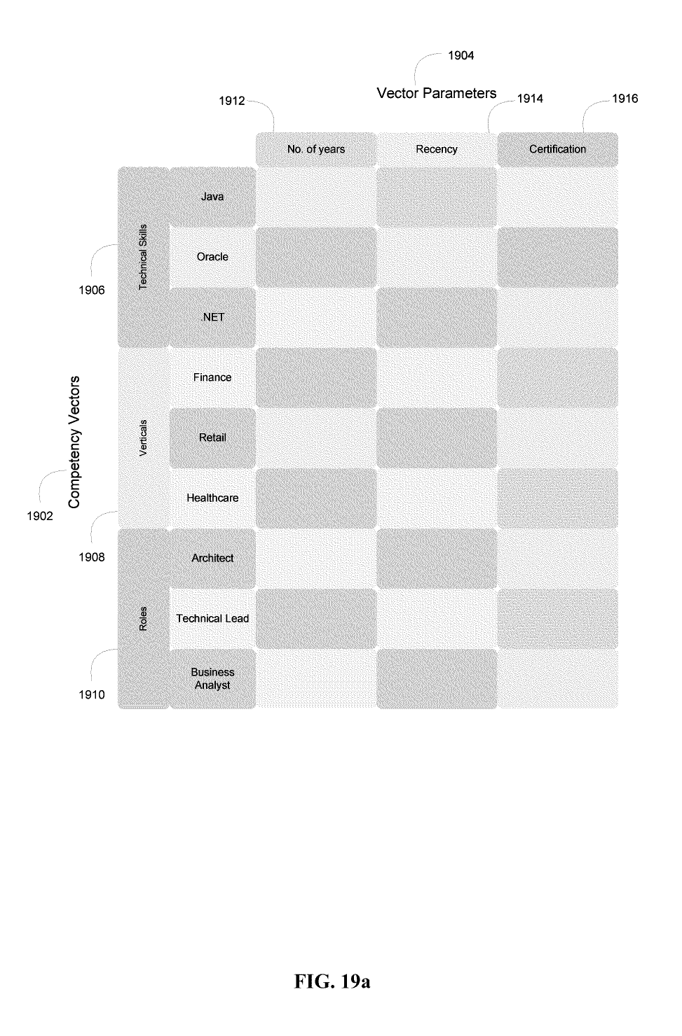

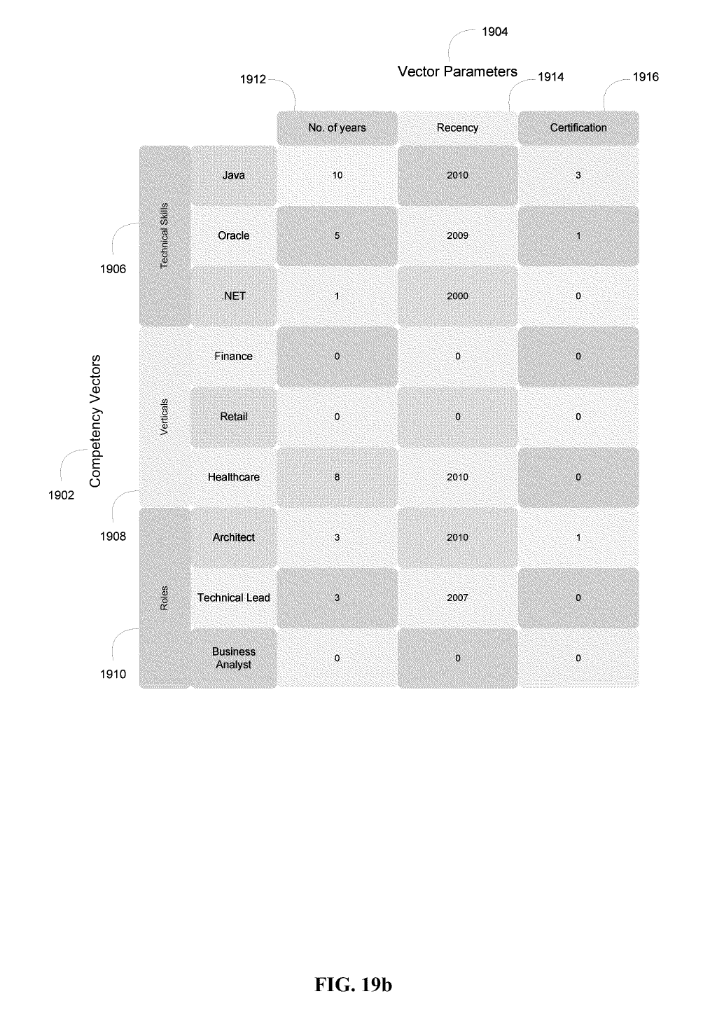

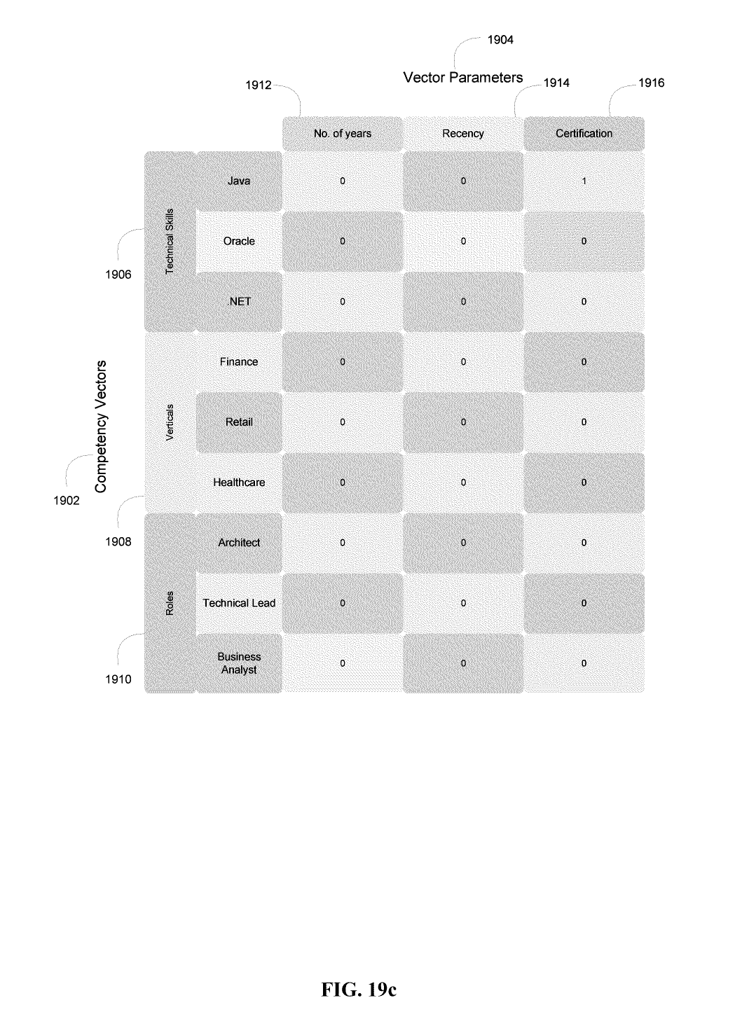

Referring to FIG. 17, in step 1712, the profile image builder 342 constructs a profile image for the candidate using the candidate's XML record. Profile image is a two dimensional artifact constructed by the multi-source talent acquisition system 100 that serves to encapsulate a holistic representation of the candidate's skills, experience and qualifications. Profile images play an important role in enabling cluster representation of candidates on the search results display panel 610 as will be detailed further on. FIG. 19a illustrates an exemplary profile image template. An embodiment of the profile image consists of several pre-defined competency vectors 1902, with each competency vector consisting of several vector parameters 1904. In the example illustrated in FIG. 19a, the competency vectors are categorized into the three broad areas of technical skills 1906, verticals 1908 and roles 1910, and include vectors representing Java, Oracle, .NET, Finance, Retail, Healthcare, Architect, Technical Lead and Business Analyst. The example illustrated in FIG. 19A, further includes vector parameters such as Number of years 1912, Recency 1914, and Certification 1916. Number of years 1912 refers to the total number of years of experience the candidate has with that skill, Recency 1914 refers to how recently the skill was put to use, and Certification 1916 refers to the number of certifications in that area. In alternate embodiments, the profile image template may be customized based on the context of use. The profile image builder 342 is a software program that scans the candidate's XML record, extracts relevant information from it and populates the fields within the profile image template. If the recently uploaded resume is identified as belonging to an existing candidate, the candidate's existing profile image is retrieved from the database 120 and is updated based on the information acquired by parsing the recently uploaded resume. FIG. 19B illustrates an exemplary profile image for a candidate.

Returning to FIG. 17, in step 1714, the created/updated profile image is saved into the database 120 within the multi-source talent acquisition system 100.

The multi-source talent acquisition system's database 120 maintains a multidimensional profile space consisting of profile images, each of which occupies a point in the multidimensional space. Each axis of the multidimensional space is characterized by a ‘competency vector-vector parameter’ combination, with the total number of dimensions being equal to the total number of ‘competency vector-vector parameter’ combinations in the profile image template. Each profile image in the multidimensional space is therefore characterized by a point, the location of which is determined by the values contained within the profile image. FIG. 19c illustrates an exemplary profile image for a candidate, whose only qualification happens to be a certification in Java. In the multidimensional space, therefore, the profile image of this exemplary candidate will find a presence on the axis representing ‘Java-Certification’ since all other values within the profile image are zero. The multidimensional space is also characterized by clusters of resources that have similar profiles, since similar vector values directly implies similar location assignments.

In step 1716, illustrated in FIG. 17, the multidimensional profile space is updated by including the newly created/updated profile image in it.

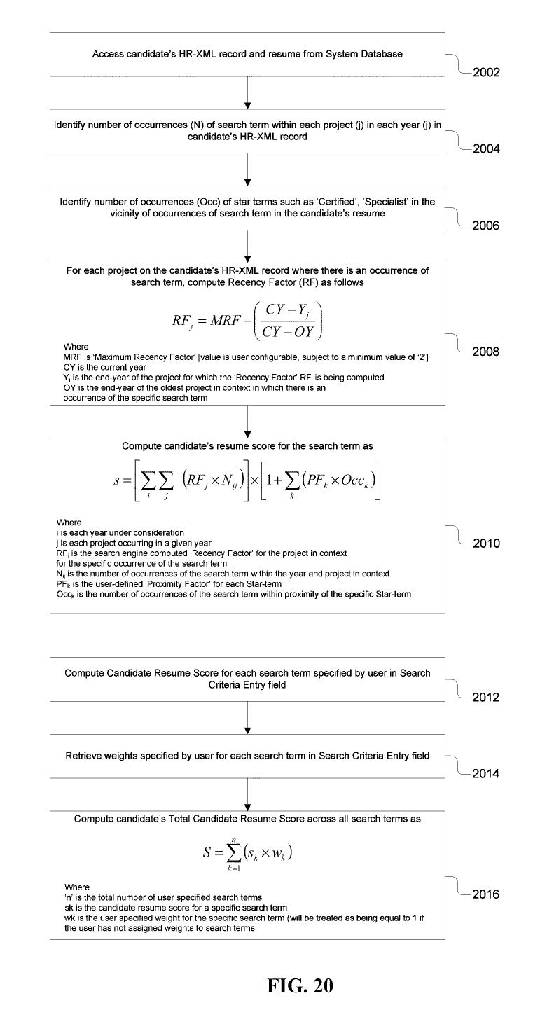

FIG. 20 is a flowchart that illustrates the method of computing the candidate's score as it pertains to the search criteria specified by the user by using the information contained with candidate's resume. In step 2002, illustrated in FIG. 20, the candidate's XML record and resume are retrieved from the database 120. In step 2004, illustrated in FIG. 20, the number of occurrences of each search term within each project in each year of the candidate's experience is identified from the candidate's XML record. In step 2006, illustrated in FIG. 20, the number of occurrences of ‘star’ terms in the proximity of occurrences of each search term in the candidate's resume is identified. ‘Star’ terms are user-defined words that are deemed by the user to indicate a degree of superiority of the skill that they are used in reference to, on the resume. Proximity is defined as the word-distance range from the search term that the star terms are to be looked and accounted for. In one embodiment, ‘certification’ and ‘certified’ may be defined as ‘star’ terms, and the proximity may be set as 5 words. In this case, the resume would be scanned to identify occurrences of the terms ‘certification’ and ‘certified’ within the range of 5 words from each occurrence of a search term on the candidate's resume. An example of such occurrence in a candidate's resume, where one of the search terms is Java, and ‘certified’ is a star term would be ‘Sun certified Java programmer’. In alternate embodiments, any term that is deemed to reflect a superior knowledge of the search term solely by the proximity of its presence to the search term may be defined as a ‘star’ term.

Returning to FIG. 20, in step 2008, for each project on the candidate's XML record where there is an occurrence of the search term, Recency Factor is computed as follows:

$${RF}_{j} = MRF - ( \frac{CY - {Y}_{j}}{CY - OY} )$$

where MRF is ‘Maximum Recency Factor’, CY is the current year, Yj is the end-year of the project for which the ‘Recency Factor’ RFj is being computed, and OY is the end-year of the oldest project in context in which there is an occurrence of the specific search term. The value of the Maximum Recency Factor is user configurable, subject to a minimum value of ‘2’.

In step 2010, illustrated in FIG. 20, the candidate's resume score for each search term is computed as:

$$s = [ {\sum }_{i} {\sum }_{j} ( {RF}_{j} \times {N}_{ij} ) ] \times [ 1 + {\sum }_{k} ( {PF}_{k} \times {Occ}_{k} ) ]$$

where ‘i’ is each year under consideration, ‘j’ is each project occurring in a given year, RFj is the search engine computed Recency Factor for the project in context for the specific occurrence of the search term, Nij is the number of occurrences of the search term within the year and project in context, PFk is the user-defined Proximity Factor for each star term, and Occk is the number of occurrences of the search term within proximity of the specific star-term.

In step 2012, illustrated in FIG. 20, the candidate resume score is computed for each search term specified by the user in the search criteria entry field 602, using the method illustrated in step 2010.

In steps 2014 and 2016, illustrated in FIG. 20, the weights specified by the user for each search term is retrieved, and the total candidate resume score across all search terms is computed as:

$$S = {\sum }_{k = 1}^{n} ( {s}_{k} \times {w}_{k} )$$

where ‘n’ is the total number of user specified search terms, sk is the candidate resume score for a specific search term, and wk is the user specified weight for the specific search term.

Search Results Display Phase

Following computation of candidate scores based on the search criteria specified by the user and the source selected by the user, matching candidates are displayed on the search results display panel 610, illustrated in FIG. 6. Each matching candidate is represented by means of a candidate object 612a, as illustrated in FIG. 6. In one embodiment, spheres labeled with the names of candidates are used as candidate objects. In alternate embodiments, any graphical shape/element may be used as candidate objects. In one embodiment, a gradient background is used on the search results display panel 610, and candidate objects are positioned on the gradient display based on the scores with the highest scorers being placed closer toward the center. The distance of a candidate object from the center of the display is a direct visual indicator of the level of match of the represented candidate with the search criteria. In another embodiment, candidate objects representing similar candidates are clustered together on the search results display panel 610. The level of similarity between two matching candidates to be displayed on the search results display panel 610 is derived by the distance between the profile images representing the two candidates in the multidimensional profile space. Since candidates with similar profiles tend to have similar profile images and hence be within close proximity in the multidimensional profile space, the candidate objects representing them on the search results display panel 610 will be clustered together. An embodiment of the search results display panel, therefore, enables the user to not only visualize the relevancy of a candidate to the indicated search criteria, but also visualize the similarities between candidates returned as a result of the search.

In one embodiment, a pre-set number of candidate objects alone are displayed on the search results display panel 610 irrespective of the total number of candidates that are identified as matching the search criteria. After having reviewed the candidates displayed on the search results display panel 610, should the user wish to view more candidates, the user zooms-out or pans using the zoom/pan control 626 to enable a higher level view of the search results display panel 610. This will result in more candidate objects coming into view on the search results display panel 610. The user may use the zoom/pan control 626 any number of times after a search is executed in order to control the number of candidate objects being displayed on the search results display panel 610.

Referring to FIG. 6, a summary of the search results is displayed in the search summary display panel 616. The information displayed in the search summary display panel 616 includes ‘number of candidates searched’, ‘number of candidates that match the search criteria from amongst those searched’, ‘number of sources searched’, and a graphical chart to represent the number of matching candidates for each component of the search criteria.

Further in reference to FIG. 6, when the user places the mouse pointer over a candidate object 612c in the search results display panel 610, a profile snapshot window 614 pops open. The profile snapshot window 614 displays the candidate's name, location, contact details, availability, score, photo, and buttons for profile display and test scheduling. Information pertaining to the candidate displayed on the profile snapshot window 614 is procured by the multi-source talent acquisition system 100 from the candidate information system 108.

When the user clicks on a candidate object 612a, information pertaining to the candidate represented by the candidate object 612a gets displayed on the candidate profile display panel 618, candidate synopsis/skills display panel 620, and the candidate score/report display panel 622. In one embodiment, the candidate profile display panel 618 includes information such as candidate's name, location, contact details, video profile, availability status, and links to external websites that carry more information about the candidate. Alternate embodiments will offer the ability to customize the information displayed in this panel. Information pertaining to the candidate displayed on the candidate profile display panel 618 is procured by the multi-source talent acquisition system 100 from the candidate information system 108.

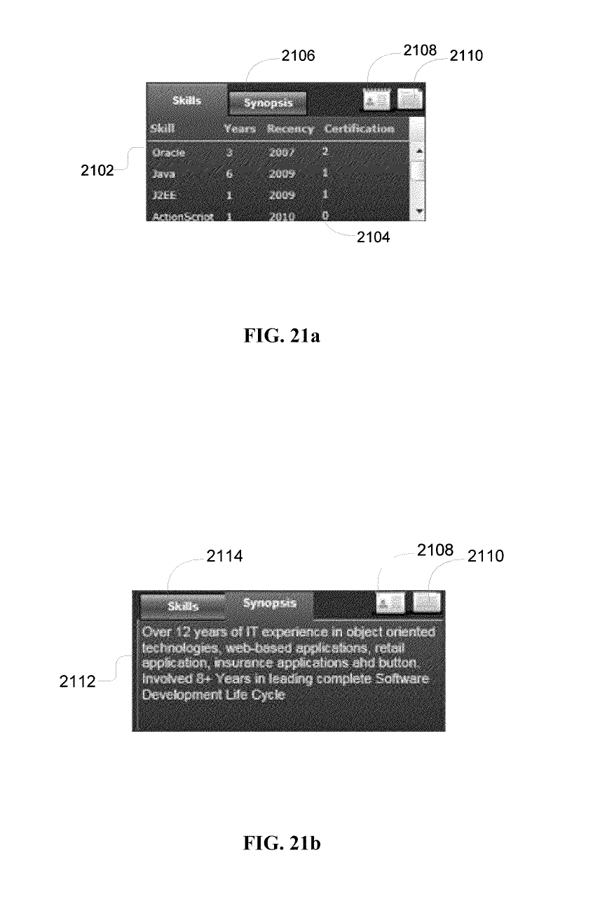

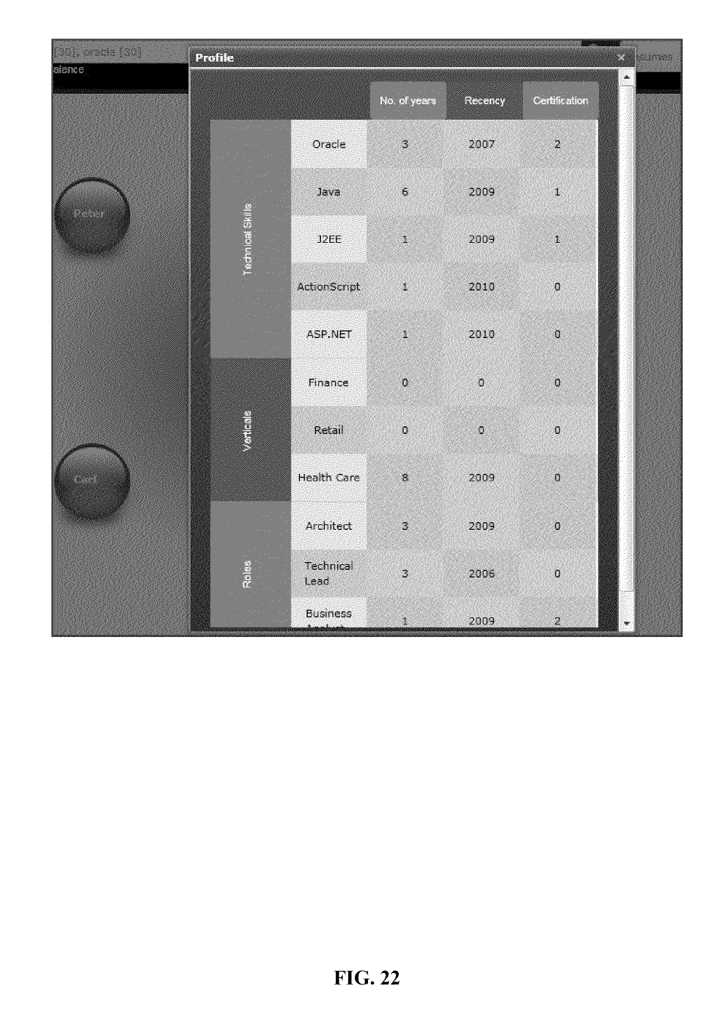

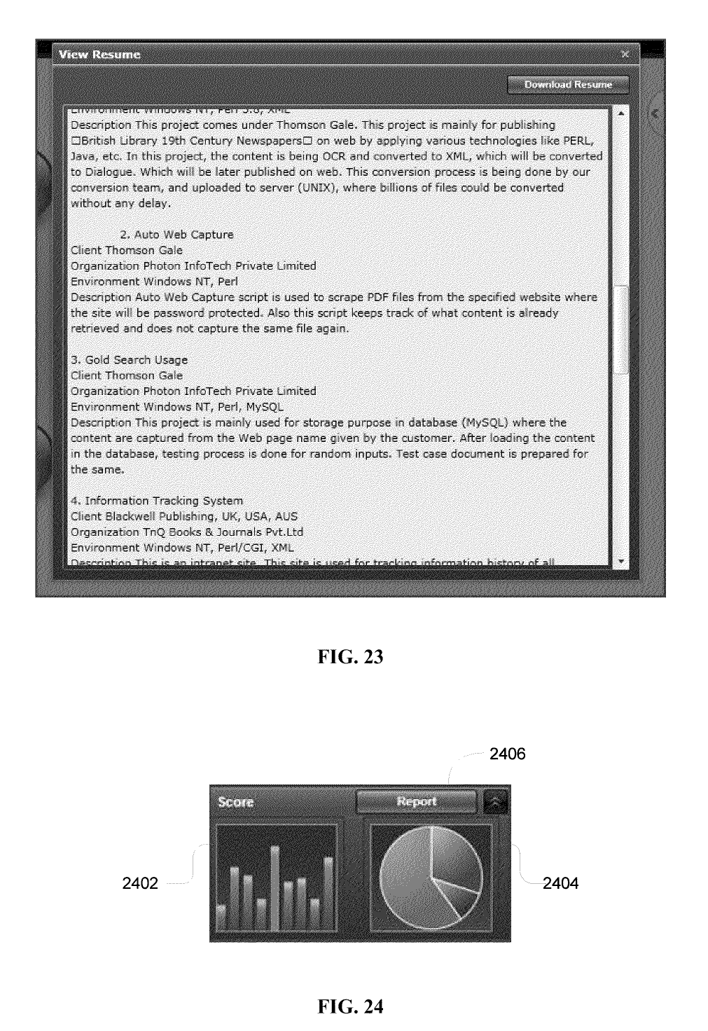

FIGS. 21a and 21b illustrate exemplary views of the synopsis/skills display panel 620. In one embodiment, the default view is as illustrated in FIG. 21a, where the user is displayed a skills matrix 2102 consisting of the number of years of experience, recency and number of certifications for each of the skills in the search criteria. When the user places the mouse pointer over an item representing the number of certifications 2104, a window pops open listing details about the certification(s). In one embodiment, this includes details such as certification name, name of the certifying agency, and date until which the certification is valid. When the user clicks on the synopsis button 2106, the synopsis/skills display panel 620 toggles view as shown in FIG. 21b to display the candidate's professional summary 2112. The user may toggle back to the skills view by clicking on the skills button 2114 illustrated in FIG. 21b. When the user clicks on the profile image button 2108, a profile image display window opens up to display the profile image of the selected candidate. FIG. 22 illustrates an exemplary profile image display window. When the user clicks on the resume button 2110, a resume display window opens up to display the candidate's resume. FIG. 23 illustrates an exemplary resume display window. An embodiment of the resume display window also enables the user to download the resume in a variety of formats.

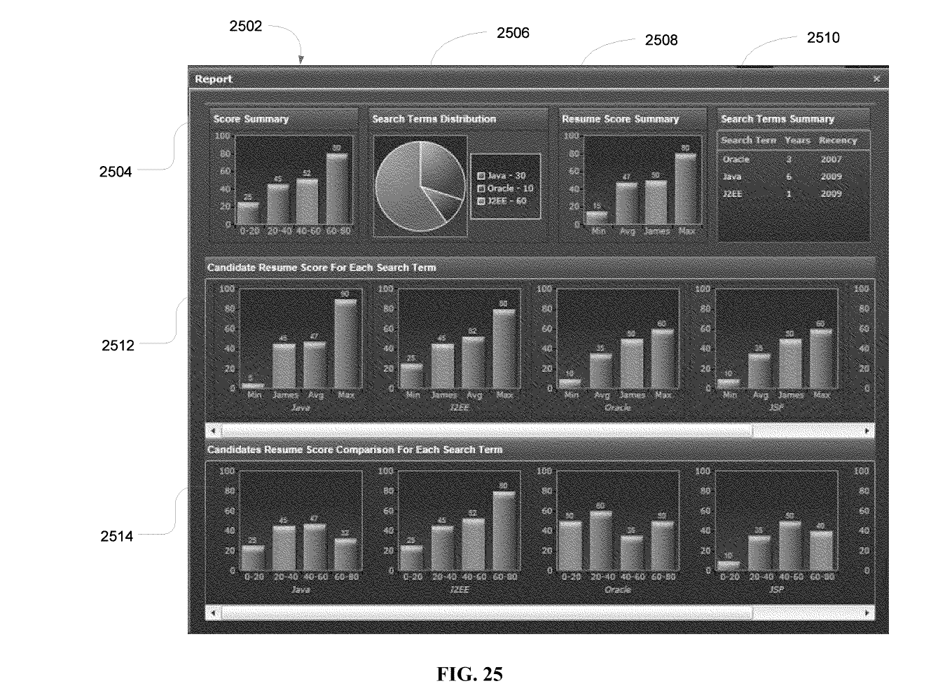

FIG. 24 illustrates a closer view of the score/report display panel 622. In one embodiment the score/report display panel includes a histogram 2402 that shows the selected candidate's score position amongst the scores of other matching candidates, and a pie-chart 2404 showing distribution of scores amongst the search terms for the selected candidate. When the user clicks on the report button 2406 in the score/report display panel 622 illustrated in FIG. 24, a report display window opens up. FIG. 25 illustrates an exemplary report display window 2502. In one embodiment, the report display window 2502 includes histogram 2504 showing selected candidate's score position amongst the scores of other matching candidates, pie-chart 2506 showing distribution of scores amongst the search terms for the selected candidate, chart comparing selected candidate's resume score with maximum resume score, minimum resume score, and average resume score 2508, search term summary including year of most recent use, and number of years of use 2510, histogram 2512 showing selected candidate's score position amongst the scores of other matching candidates for each search term, chart 2514 comparing selected candidate's resume score with maximum resume score, minimum resume score, and average resume score for each search term.

The user may shortlist a candidate for further assessment, by selecting a candidate object 612a representing a candidate, and clicking on the schedule test button located in the shortlisted candidates panel 624. In another embodiment, the user may also add candidates to the list in the shortlisted candidates panel 624 by clicking on the ‘add to schedule test’ button in the profile snapshot window 614 that pops up while placing the mouse pointer over a candidate object. Information regarding the shortlisted candidates is transmitted by the multi-source talent acquisition system 100 to the test system 112 and/or the interview system 114 for scheduling and administration.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

We claim:

1. A method for performing a multi-source talent acquisition, the method comprising:
entering search criteria;
selecting at least one source from a plurality of sources;
executing a search using at least the search criteria and the at least one source;
identifying at least one talent match; and
displaying the at least one talent match.

2. The method of claim 1, wherein entering the search criteria includes assigning varying weightage to components of the search criteria.

3. The method of claim 2, further comprising integrating with a position profile registration system to access and retrieve the search criteria pertaining to a predefined position.

4. The method of claim 1, further comprising accessing and analyzing objective and standardizing information on a candidate's capabilities and executing a contextual information search through at least one resume to identify and recommend talent.

5. The method of claim 1, further comprising integrating with at least one assessment system, accessing, retrieving and analyzing relating to a candidate's performance for evaluating candidature for a position, based at least on standardized and objective information.

6. The method of claim 5, further comprising analyzing a candidate's performance across multiple past assessments having relevance to skills and qualifications embodied in a position profile for which at least a part of a search is being executed for.

7. The method of claim 1, further comprising searching and evaluating candidates based on information stored in an interview system.

8. The method of claim 7, further comprising computing a candidate's fit as it pertains to a specified search criteria utilizing interview assessment data, taking into account a volume of historical assessment data available for each candidate and defined weightage for at least one search term and candidate performance across the at least one question relevant to the search term, and the complexity of the such question.

9. The method of claim 1, further comprising acquiring resumes using instructions that monitors arrival of new resumes into a candidate information system resume repository by a multisource talent acquisition system and processing the resumes.

10. The method of claim 1, further comprising representing candidates using graphical objects in a two dimensional space, where candidates with similar profiles are clustered together.

11. The method of claim 1, operating on a system for computing a total candidate test score for at least one candidate utilizing parameters, the system comprising:
a memory for storing instructions and data, the data comprising a set of programs and a dataset having one or more data fields; and
a server that executes the instructions and processes the data.

12. The method of claim 11, wherein the system further comprises integrating with a position profile registration system to access and retrieve the search criteria pertaining to a predefined position.

13. The method of claim 11, wherein the system further comprises accessing and analyzing objective and standardizing information on a candidate's capabilities and executing a contextual information search through at least one resume to identify and recommend talent.

14. The method of claim 11, wherein the system further comprises computing a candidate's fit as it pertains to a specified search criteria utilizing interview assessment data, taking into account a volume of historical assessment data available for each candidate and defined weightage for at least one search term and candidate performance across the at least one question relevant to the search term, and the complexity of such question.

15. The method of claim 11, wherein the system further comprises acquiring resumes using instructions that monitors arrival of new resumes into a candidate information system resume repository by a multisource talent acquisition system and processing the resumes.

16. A method for performing a multi-source talent acquisition, the method comprising:
computing a candidate's fit as it pertains to a search criteria specified by a user utilizing test assessment data taking into account a volume of historical assessment data available for each candidate, user defined weightage for each search term and a performance of a candidate across all questions relevant to a search term.

17. A method for performing a multi-source talent acquisition, the method comprising:
performing a contextual information search on the resumes;
evaluating a context of occurrence of each search term on the resumes in order to efficiently value real-world project experience;
efficiently valuing at least one recent project experience; and
identifying and valuing possible certifications and specialist level skills.

18. The method of claim 17, further comprising constructing profile images for at least one candidate using the at least one candidate's resume and an XML record, where the profile image is a multidimensional artifact encapsulating a holistic representation of the at least one candidate's skills, experience and qualifications.

19. The method of claim 17, further comprising representing candidate information in a multidimensional artifact where candidates with similar profiles are clustered together in a multidimensional characteristic space.

20. The method of claim 17, further comprising computing a recency factor for each project on the candidate's XML record where there is an occurrence of the search term.

21. The method of claim 17, further comprising identifying a number of occurrences of star terms in proximity of the occurrences of each search term in the candidate's resume, where star terms indicate a degree of superiority of a skill used in the resume, and where proximity is defined as a word distance range from the search term that the star terms are to be looked and accounted for.

22. The method of claim 17, further comprising computing a candidate's resume score for each search term based on a number of occurrences of the search term, context of the occurrence, recency of use, number of occurrences of star terms with proximity of the search term.

23. The method of claim 17 operating on a system, the system comprising:
a memory for storing instructions and data, the data comprising a set of programs and a dataset having one or more data fields; and
a server that executes the instructions and processes the data.

24. The method of claim 23, wherein the system further comprises constructing profile images for at least one candidate using the at least one candidate's resume and an XML record, where the profile image is a multidimensional artifact encapsulating a holistic representation of the at least one candidate's skills, experience and qualifications.

25. The method of claim 23, wherein the system further comprises representing candidate information in a multidimensional artifact where candidates with similar profiles are clustered together in a multidimensional characteristic space.

26. The method of claim 23, wherein the system further comprises computing a candidate's resume score for each search term based on a number of occurrences of the search term, context of the occurrence, recency of use, number of occurrences of star terms with proximity of the search term.

27. The method of claim 1 operating on an integrated platform executing precision searches and viewing talent that has been identified, evaluated and ranked based on information procured from multiple sources, the platform comprising a multi-source talent acquisition system that executes instructions and processes data.

28. The platform of claim 27, further comprising a user interface communicating with at least the multi-source talent acquisition system enabling specifying a search criteria, selecting a source, displaying search results, displaying search summaries, displaying candidate information and reports, displaying resume and profile images, and providing a panel to select and specify candidates for further assessment.
